(19) United States
(12) Patent Application Publication
(10) Pub. No.: US 2008/0243549 A1
(43) Pub. Date: Oct. 2, 2008

(54) Patient care report management system

(76) Inventors: Michael T. Woronka, Methuen, MA (US); Peter Viele, Sutton, MA (US); Joseph Simone, Hudson, NH (US)

Correspondence Address: NORMA E HENDERSON;HENDERSON PATENT LAW, 13 JEFFERSON DR, LONDONDERRY, NH, 03053, US

(21) Appl. No.: 11/731,753

(22) Filed: Mar. 31, 2007

(51) Int. Cl. G06Q 50/00

(52) U.S. Cl. 705/3

(57) ABSTRACT

In an integrated web-based software system for tracking and managing patient care reports associated with emergency medical transport trips, a thin web-based client is viewable through the Internet, including wirelessly from within emergency vehicles, and communicates with a main system that is designed around a core layered architecture with at least one system database and a web-based interface. The system facilitates report entry and delivery to hospitals and end-user administration, including the ability to create new fields and tabs for the run form, notifications about relevant data conditions, continuous reporting capabilities, and on the fly data updates. The system particularly provides the options of prefilled web forms, report and field administration, changeable data entry, automatic information sharing to destination facilities and internal departments, quality assurance notifications, summary data, and data mining, as well as optional interfaces to Third Party software products commonly used in the industry.

### FIELD OF THE TECHNOLOGY

The present invention relates to software for managing medical data and, in particular, to a software system for tracking and managing patient care reports associated with emergency medical transport trips.

### BACKGROUND

The Commonwealth of Massachusetts requires that emergency medical transport services provide a Patient Care Report to the destination facility or hospital receiving the patient. The Joint Commission on Accreditation of Health Care Organizations (JCAHO) also requires proof that Patient Care Reports are being passed from the pre-hospital ride directly to emergency room staff. In addition, Emergency Medical Services (EMS) providers also must comply with the Health Insurance Portability and Accountability Act of 1996 (HIPAA) by ensuring that only the appropriate people have access to information on each patient.

For each patient, a Patient Care Report must therefore be filled out that details pertinent patient information and what has been done to the patient from the time that the EMTs and paramedics arrived to the time that the patient arrived at the hospital. The Patient Care Report must include such items as the chief complaint, a history of the present illness, and a complete medical/physical examination, such as an assessment of the head, eyes, ears, nose, throat, neck, chest, abdomen, pelvis, extremities, cardiovascular system, respiratory system, and integrity of the skin. In essence, all of the things typically assessed within a physician's office must also be documented for each and every patient contact with emergency services.

For a long time, paper “run forms” with carbon copies have been used to share this information between ambulance crews and emergency room staff. A copy is then later brought into the billing department of the emergency services provider. These paper run forms are still being used in most places. There are many problems with this process. First, paper processing takes time. For EMS providers that see 25,000-30,000 patients a year, processing all of this paperwork can be an administrative nightmare. It requires reconciling information from the run report with information received from the initial call to dispatch, dependency on paper being transported from one location to another, and legible handwriting, which is frequently not easy to come by in emergency situations. Paper processing is also expensive, and run forms themselves may cost as much as 35 cents each.

Further, data located solely on paper forms cannot be used for other purposes. When data is on paper, it cannot be summarized or analyzed in real time, because doing so would require vast amounts of data entry. When data is on paper, it is therefore impossible to get instant results to research questions, and protocol violations are difficult to detect and handle. With slow paper processes that need to be reconciled with other information systems, such as dispatch information, GPS information, and fleet maintenance information, opportunities for research on clinical data from ambulance trips remain untapped. For this reason, many organizations spend a tremendous amount of effort, time, and money on entering paper-based data into electronic databases.

One alternative to the use of paper forms is physician dictation technology, wherein the technician calls up on a telephone and dictates a run report, which is then transcribed. This does not solve the problem of providing a run report to the emergency room or receiving facility as soon as the patient is transported and the run report is completed. This technology also requires human interaction to assure that all of the required processes are being followed, and it consequently requires additional labor time to complete all of the steps.

An alternative to hand entry of data is scanning technology, but with scanning the readability of handwriting is still an issue. Further, scanning technology can be limited in its ability to recognize certain characters. Scanning systems can also be hard to use, and require that run forms be brought into the headquarters office, resulting in intensive labor and technical requirements for scanning in hundreds of run sheets. The resulting errors and delays can be very costly.

Another alternative is a pen-based system, such as those from Medusa and Pinpoint. Among the drawbacks of pen-based systems is that they require that many types of hardware be purchased, developed, programmed, and carried by field providers, plus the field unit must be returned to the office in order to download the information to the computer system. The cost of the hardware required further presents a substantial barrier to use.

Currently, there are some systems for managing medical data that employ Palm Pilot and/or other PDA operating systems for data collection, including Pocket PC and Windows CE. Many of these applications have been custom built by individual organizations. For example, the San Diego Fire Department has developed a Palm Pilot-based patient data collection system. A problem with this approach is that Palm Pilot-style applications, Windows CE applications, and pocket applications cannot be synchronized with the parent computer-aided dispatch database without taking them back to the location of the parent database for synchronization.

Another existing option is a client/server patient data collection system. Examples of commercial client/server systems with thick clients are those from Firehouse, Phisio-Medusa, BioKey, and Zoll. Some systems have also been custom built—for example, the State of Delaware has developed a client/server-based system in which the client is installed in PCs throughout the state and then each client individually communicates back to the main state server. All of these applications require some type of client/server synchronization function. Further, installation and maintenance of the full computer needed to run the client for each individual ambulance crew would require a great deal of labor and money, and the systems do not necessarily integrate with other software already being used, such as existing installed computer-aided dispatch and/or billing software.

Clearly, an electronic patient data collection mechanism is needed, one that is easily integrated with the computer-assisted dispatch system in real time. However, it can be extremely expensive, as well as time-consuming from a labor standpoint, to purchase hardware and to have someone administer the hardware and make sure that the machines are accurate and synchronized. At present, there is no simple mechanism for synchronization of data between available electronic data collection mechanisms and commercially available computer-aided dispatch (CAD) systems. Further, the education and training on these machines can be time-consuming and expensive. A successful system would need to be easy to deploy and easy for crews to utilize.

One option is an integrated IT system into which crews can enter data themselves, cutting the cost of labor from a data entry standpoint and enabling research-related and other database queries on the data. Multiple systems need to work together to meet the goals of eliminating handwritten reports, enabling printing a well-documented, clear, and concise run report, and collecting data on what employees are doing, on what types of patients are seen, and on what medications are being administered. Typical IT systems, however, have hidden costs, and the existing systems do not integrate with the commercially available CAD systems that are already in use. These products are typically “canned”, with limited flexibility, so changing the data to be collected requires that technical support requests be generated.

A solution is to use the Internet to assist with the data collection process and printing of run reports. Ideally, crews could sit in the ambulance to enter data and then fax or print a run report at the receiving emergency room or other location that received the patient. In this way, crews could access needed data from anywhere. However, an issue with developing a web-based system that is client/server-based with a thick client, Windows CE-based, or Pocket PC-based, however, is the cost of purchasing and running hardware capable of running all of the needed applications. Full computers with software licensing for all vehicles can be an extremely expensive option, with just the cost of hardware alone being up to $12,000 per vehicle. Utilization of such hardware for data collection is therefore cost prohibitive, as well as representing a never-ending cost due to the constant need to adapt to advances in the technology. A less expensive option is therefore needed.

By utilizing the Internet with a thin client and a web-based collection database, a user could connect to it from anywhere in the world and enter data. For the most part, advances in technology would be isolated to the server side and transparent to the end user. Some thin client web-based software currently does exist, such as EMS Charts (with an Oracle database out of the University of Pittsburgh), ESO Solutions, Scan Health, and Motorola 90 degrees. What is needed, however, is software that is integrated with existing CAD systems and the various other databases and applications that service providers already employ—otherwise, either the startup costs for data transfer will be very high, or the current problems with data transfer and lack of interoperability of systems will persist.

### SUMMARY

The present invention is an integrated web-based software system for tracking and managing patient care reports associated with emergency medical transport trips. In one aspect, a thin web-based client is viewable through the Internet, including wirelessly from within emergency vehicles, and communicates with a main system that is designed around a core layered architecture. The system of the present invention supports all of the activities associated with the process flow of patient care report form entry, delivery, and retention. Particular benefits include facilitation of end-user administration, provision of notifications about relevant data conditions, continuous reporting capabilities, and on the fly data updates. In one aspect, the system provides prefilled web forms, changeable data entry, automatic information sharing, unlocking of trips, quality assurance notifications, summary data, and data mining. In another aspect, the present invention provides functionality for creating, editing, deleting, and managing reports generated from the patient care report record database. The system provides a mechanism to specify and generate email notifications based on various system events. The system further provides a mechanism through which patient care report records can be locked from further changes to preserve accuracy.

In a preferred embodiment, the core layered architecture comprises a Database Management Layer, General Data Collection System Abstraction Layer, a Presentation Layer, a Browser, one or more system databases, and an optional interface to a computer-aided dispatch system. An embodiment with an enhanced architecture may further include interfaces/integration with one or more cell phones, fax servers, email systems, and optional Third Party databases, such as Fleet Management software, Time and Attendance software, and/or Incident Management software. In a preferred software implementation, software modules include an administrative dashboard, user and contact administration, a PCR Data Collection System including a Compliance Checklist function, Turned In Checklist function, and an Electronic Run Form function, a Search PCRs function, Report administration, a Notification System including an Email/fax PCRs function, an Event notification function, and a Self-monitoring and notification function, a System Monitoring and notification function, a Human Resources (HR) function, and an Online Help function.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a diagram of the core system architecture of an embodiment of a Patient Care Report System according to the present invention;

FIG. 2 is a diagram of the enhanced system architecture of a preferred embodiment of a Patient Care Report System according to the present invention;

FIG. 3 is a diagram of the software modules that comprise an example embodiment of a Patient Care Report System according to the present invention;

FIG. 4 is a screen shot of an embodiment of the administrative control page (“dashboard”), according to one aspect of an embodiment of the present invention;

FIG. 5 is a screen shot of a list of all trips, as would be seen by an administrator, according to one aspect of an embodiment of the present invention;

FIG. 6 is a screen shot of a list of trips taken by a general user, as would be seen by that user, according to one aspect of an embodiment of the present invention;

FIG. 7 is a screen shot of an embodiment of a screen from which report format editing may be initiated, according to one aspect of an embodiment of the present invention;

FIG. 8 is a screen shot of the native format of a report being edited, according to one aspect of an embodiment of the present invention;

FIG. 9 is a screen shot of a populated version of an edited report, according to one aspect of an embodiment of the present invention;

FIG. 10 is a screen shot of an embodiment of the screen used by a crew member to enter a Patient Care Report, according to one aspect of an embodiment of the present invention;

FIG. 11 is a screen shot of the screen used by a crew member to enter a Patient Care Report patient assessment overview, according to one aspect of an embodiment of the present invention;

FIG. 12 is a screen shot of a Patient Care Report patient head, eye, and neck assessment entry screen, according to one aspect of an embodiment of the present invention;

FIG. 13 is a screen shot of an embodiment of a screen from which field administration may be initiated, according to one aspect of an embodiment of the present invention;

FIG. 14 is a screen shot of an embodiment of a screen at which tab administration may be performed, according to one aspect of an embodiment of the present invention;

FIG. 15 is a screen shot of an embodiment of a checklist screen, according to one aspect of an embodiment of the present invention;

FIG. 16 is a screen shot of an embodiment of a compliance checklist screen that permits identification of deficiencies in any Patient Care Report, according to one aspect of an embodiment of the present invention;

FIG. 17 is a screen shot of an embodiment of a compliance checklist screen that facilitates sending notification of Patient Care Report deficiencies to the appropriate party, according to one aspect of an embodiment of the present invention;

FIG. 18 is a screen shot of an embodiment of the screen into which facility fax numbers are entered, according to one aspect of an embodiment of the present invention;

FIG. 19 is a screen shot of a Microsoft Outlook screen showing confirmations that each Patient Care Report was either sent or a failure to be addressed, according to one aspect of an embodiment of the present invention;

FIG. 20 is a screen shot of an example of an email notification of the occurrence of an event, according to one aspect of an embodiment of the present invention;

FIG. 21 is a screen shot of an example of an Out-of-Chute notification email that support staff might receive, according to one aspect of an embodiment of the present invention;

FIG. 22 is a screen shot of an example of a Late Response notification email, according to one aspect of an embodiment of the present invention;

FIG. 23 is a screen shot of an example of an Out of Service notification email that the support staff might receive, according to one aspect of an embodiment of the present invention;

FIG. 24 is a screen shot of an example signoff message indicating actions that still need to be completed, according to one aspect of an embodiment of the present invention; and

FIG. 25 is a screen shot of an example outbound Patient Care report fax queue, according to one aspect of an embodiment of the present invention.

### DETAILED DESCRIPTION

The present invention is an integrated web-based software system for tracking and managing patient care reports associated with emergency medical transport trips. In a preferred embodiment, a thin web-based client is viewable through the Internet, including wirelessly from within emergency vehicles, and communicates with a main system that is designed around a core layered architecture with at least one system database and a web-based interface. The system of the present invention supports all of the activities associated with the process flow of patient care report form entry, delivery of the form to the appropriate customers (hospitals), and report retention.

Particular benefits of the present invention include, but are not limited to: facilitation of end-user administration, including the ability to create new fields and tabs for the run form as needed; provision of notifications about relevant data conditions via email, phone, pager, text message, instant message, and/or fax; continuous reporting capabilities, customizable by the user of the software; and on the fly data updates, with no need to wait for synchronization with other database systems. The present invention also provides a way to obtain performance data on employees, permits employees to obtain such data about themselves in order to benchmark themselves against other employees, permits identification of cost-cutting opportunities, assures that better information is obtained on patients, and reduces data entry in the billing office. The system of the present invention particularly meets these needs by providing prefilled web forms, changeable data entry, automatic information sharing to destination facilities, automatic information sharing to internal departments, unlocking of trips, quality assurance notifications, summary data, and data mining.

System Overview. The present invention is a flexible, extensible, reliable tracking system for Patient Care Reports (PCRs) generated by emergency personnel. It provides a workflow model that aligns with business and operational processes, allowing for changeable, customizable presentation of Patient Care data and rolled-up statistical reporting. The system is integrated with web, email, phone, and fax systems to provide notification of, and transmission of reports to, appropriate audiences, such as hospitals, ambulance crews, supervisors, and administrators. The system is designed to take in information from multiple sources, allowing it to be easily communicated to all types of audiences in real-time, to automatically notice any red flags, and to notify appropriate parties who can handle each situation.

In one embodiment, the present invention employs automatic vehicle location data communication in the form of a Global Positioning System (GPS) data communication modem that is physically present in the vehicle. A simple machine with a web browser and a wireless modem is placed in each vehicle, permitting crews to communicate directly back to the base and to complete a patient care report while seated in the ambulance or a waiting area. This provides one of the major benefits of the invention, in that TCP/IP provides a highly dependable and uniform way to communicate, and data is sent to the database in real-time as it is entered. A currently implemented embodiment of the present system employs a 19.2 kilobyte per second GPS modem, but clearly any of the many other wireless communication devices that are technologically feasible and would provide a satisfactory response time to the user may be advantageously employed in the invention.

The preferred embodiment of the present invention automatically faxes and/or emails a patient care reports to the receiving facility, depending on the preferred contact information entered for the facility, as soon as crew members sign off on the trip using the system. If a technology failure occurs for any reason, EMS personnel are notified immediately and can either print a report print a report from the screen and hand-deliver it to the receiving facility, or send the report again from any other location until it is received. The report can also optionally be printed and sent via mail as an original or confirmation copy. This permits hospitals to be HIPAA compliant and to meet the requirements of JCAHO that the hospital show and verify that EMS agencies are providing written copies of run reports to the hospital, in order to make sure that there is information being passed from the pre-hospital ride right to the emergency room staff.

All the applications and data storage are preferably kept in house. To function well with a wireless device, the client side is optimally thin enough to refresh quickly on any available wireless connection. The present invention is preferably implemented as a fully web-based application in order to allow access from any computer with a standard browser. It is designed as a lightweight interface in order to limit the client overhead associated with the presentation of options and the collection of data, so as to facilitate reasonable functional access by devices in remote vehicles with wireless modem access. While a preferred embodiment employs a wireless device, it will be clear to one of ordinary skill in the art that the present invention can also advantageously employ a hardwired device for hosting the client and/or the system can be accessed directly through a web browser running on the system server. Administration of users, reports, and data collection options are all accessed through a web-based interface. A centralized method is provided for storing and retrieving the status and history of any patient care report record, including the ability to track all information deemed necessary to evaluate and maintain patient care report records. A full tracking history is kept for each record indicating the activity and user access.

In one aspect, the present invention provides functionality for creating, editing, deleting, and managing reports generated from the patient care report record database. This may be customized through a web-based interface by the administrator or by assigned users. The system provides a mechanism to specify and generate notifications based on various system events. The notifications generated are configurable through a web-based interface by the administrator. The system further provides a mechanism through which patient care report records can be locked from further changes (except dated annotations) to preserve accuracy. In one aspect, it may optionally include a facility for the attachment, through the web-based interface, of various documents and files (such as EKG printouts) pertinent to a given patient care report record. Preferably, the system provides user password authentication and is accessible only from the company intranet or through designated remote access. Additional levels of access may optionally be available in order to, for example, allow outside agencies to retrieve patient care data without gaining access to records outside of their responsibility (such as, for example, a report on a patient who was taken to a different hospital).

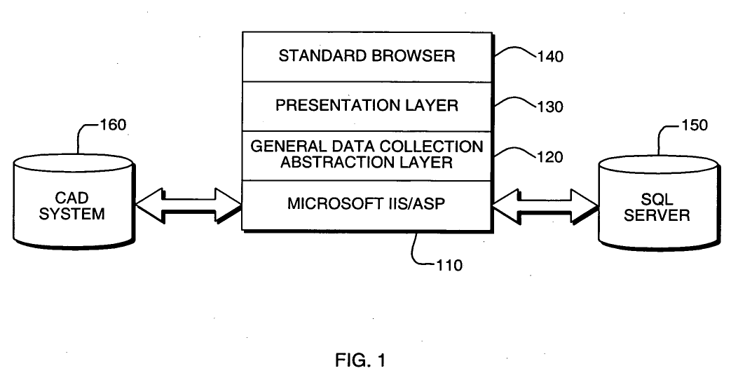

System Architecture. In a preferred embodiment, the present invention is designed around a core layered architecture to allow for ease of maintenance and customization. It has an architectural design that takes into consideration the maintenance and updates of the system, allowing updates to database technology to be relatively minimum, while still providing flexibility for a wide variety of changes in functionality. The abstracted, layered model permits strategic, focused maintenance and support, with changes easily configured by users of the software through the front-end web pages. In a preferred embodiment, the present invention can be implemented using standard IT tools, applications, and solutions, such as Microsoft IIS Web Server and Active Server Pages (ASP). An embodiment of a preferred core system architecture is depicted in FIG. 1.

In FIG. 1, Database Management Layer 110 manages storage and retrieval of data from and to the system databases and is used to serve up ASP pages to the Internet. In a preferred embodiment, Layer 110 is implemented with Microsoft IIS Web Server or a similar system, with Microsoft Active Server Page (ASP) scripting language for both client-side and server-side scripts. General Data Collection System (GDCS) Abstraction Layer 120 is an abstract collection of API routines for use with the system data structure. This abstraction allows for a simple definition of data fields, layout information, corresponding SQL data elements, and validation information through the use of flat text files (ASP code stored on the server). This provides a very simple mechanism for the customization of the application for changes in data fields and process flow, as well as creating an environment for simple customization for additional related applications. Presentation Layer 130 is a collection of functions and subroutines used to roll up the display of various data elements, form elements and interfaces, and general layout. This simplifies the core coding effort, and provides a more consistent look and feel to the overall system. The present invention is a fully web-based interface for data entry, reporting, and maintenance. Any browser 140 that supports Javascript, such as Internet Explorer, can be advantageously employed with the system, including lightweight versions such as those found on Windows CE devices. System database 150 is used for data storage and retrieval. In a preferred embodiment, the database is MicroSoft SQL based, but any other commercially available or homegrown database software may be advantageously adapted for the present invention. The system further optionally supports integration and retrieval of data from computer-aided dispatch system 160, providing the capability of automatic completion of appropriate parts of the patient care report.

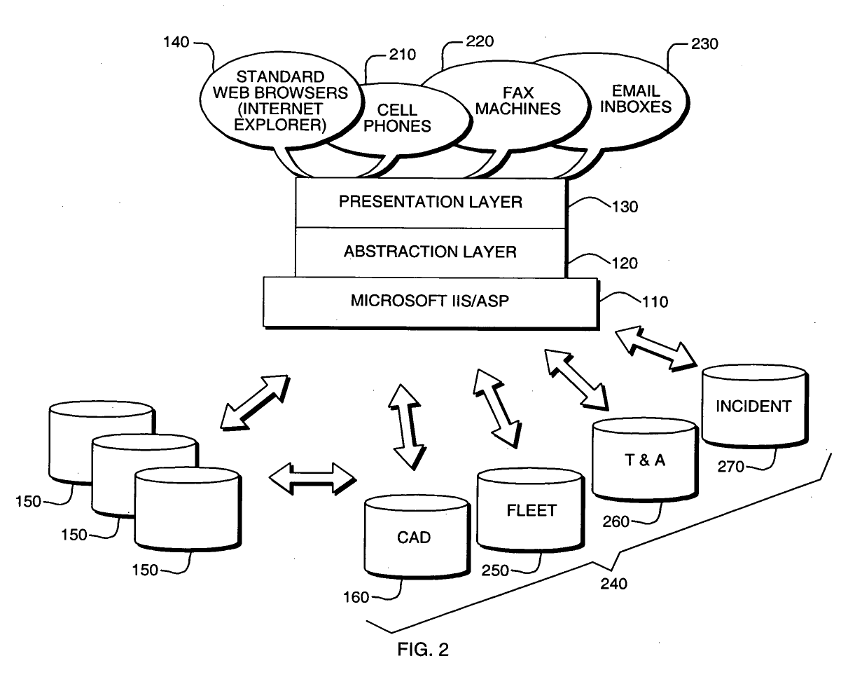

An enhanced architecture can be built around the core layered architecture of FIG. 1, as shown in FIG. 2. In FIG. 2, core layers Database Management Layer 110, General Data Collection System (GDCS) Abstraction Layer 120, Presentation Layer 130, browser 140, and System databases 150 are optionally integrated with one or more cell phones 210, one or more fax servers 220, one or more email systems 230 and one or more optional Third Party databases 240, such as computer-aided dispatch system 160, Fleet management software 250, Time and Attendance (T & A) software 260, and/or Incident management software 270.

In a preferred embodiment, the present invention has several functional modules that interact with one another. Some of these modules reside in the core of the software and some are optional add-ons, including interfaces with third party tools. An overview of the functionality of each module is shown in Table 1.

TABLE 1

| System | Module | Provides the Ability To: |
|---|---|---|
| Main | Dashboard | Drive the way that the software works for you. Different |
| | | functionality is available depending on which user is |
| | | viewing the dashboard. |
| | Users and | Place users into groups with different access privileges, |
| | Contacts | starting web pages to view, notifications and reports |
| | | available. |
| | Search | Search through an appropriate subset of PCRs based on |
| | PCRs | each user or group. |
| | Reports | Choose and lay out PCR fields to include in reports, or use |
| | | a Crystal Report. |
| Data | Electronic | Specify, create, edit, and toggle fields, tabs, and online |
| Collection | Run Form | help for crews to enter PCR information. |
| | Turned In | View and change the status of each PCR. Mark PCRs |
| | Checklist | complete that have been turned in on paper, and reopen |
| | | PCRs as needed. |
| | Compliance | Create and utilize a checklist of rules for PCRs to be |
| | Checklist | compliant with company or government policies. |
| Notification | Email/Fax | Automatically email and/or fax an electronic PCR report to |
| | PCRs | the destination facility when ambulance crews sign off. |
| | Events | Send notification to users or user groups for day-to-day |
| | | events in EzPcr. |
| | Monitor | Automatically monitor all databases in the system, |
| | | including the EzPcr databases and any third party |
| | | databases being used, so as to catch any operational |
| | | issues and notify appropriate parties. |
| HR | HR | Collect additional feedback about each employee and |
| | | report on it in a systematic way for performance reviews. |
| Third Party | CAD System | Automatically pre-fill PCR fields from a Computer Aided |
| Interfaces | | Dispatch System. |
| | Incident | Track and respond to services-related events. |
| | Manager | |
| | Fleet | Track and manage vehicle condition and stocking. |
| | Management | |
| | Time and | Prevent employees from punching out until their PCR |
| | Attendance | reports of the day have been completed. |

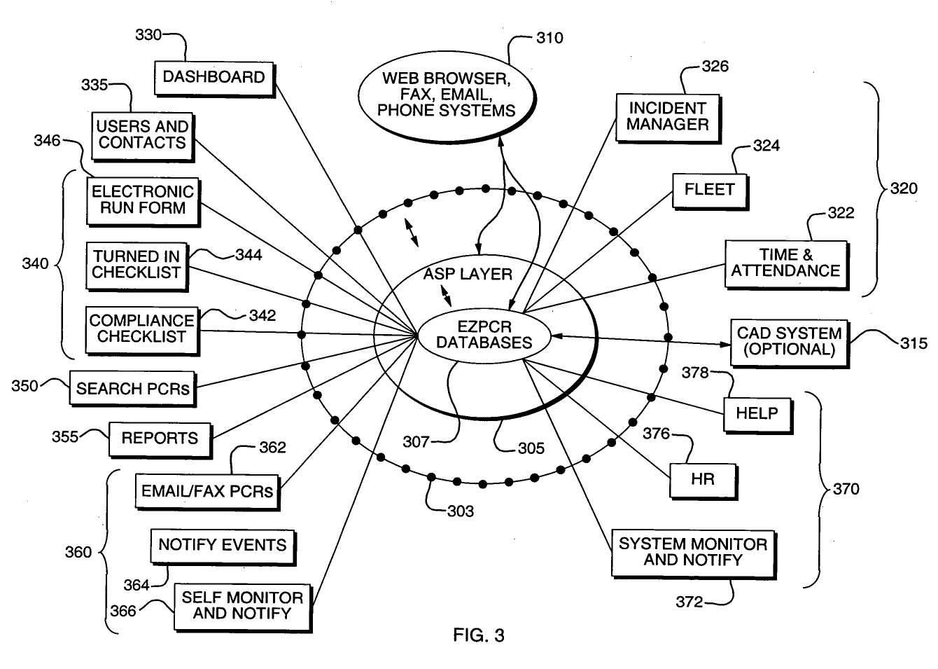

An overview of the architecture and modules for a preferred software implementation of the present invention is shown in FIG. 3. In FIG., 3, core architecture 303, including Database Management/ASP layer 305 and system databases 307 interfaces with Web browser 310, optional CAD system 315, and other optional Third Party interfaces 320, such as Time and Attendance software 322, Fleet management software 324, and Incident management software 326. Functionality implemented in the preferred embodiment of FIG. 3 includes administrative dashboard 330, user and contact administration 335, and PCR Data Collection System 340. Data Collection System 340 may include various functionalities, and in the preferred embodiment of FIG. 3 includes at least Compliance Checklist function 342, Turned In Checklist function 344, and Electronic Run Form function 346. Other functionalities available include Search PCRs 350, Report administration 355, and Notification System 360. Notification System 360 may include various functionalities, and in the preferred embodiment of FIG. 3 includes at least Email/fax PCRs function 362, Event notification function 364, and Self-monitoring and notification function 366. Optional additional systems 370 may also be included, such as System Monitoring and notification function 372, Human Resources (HR) function 376, and Online Help function 378. In general, in FIG. 3, the lines and arrows represent communication paths. It is clear that all the functionalities interconnect, which provides the advantage of flexibility to the present invention. For example, System Monitor and Notify function 372 can also monitor the third party databases being used. Further details regarding the functional modules of FIG. 3 are provided in the text that follows.

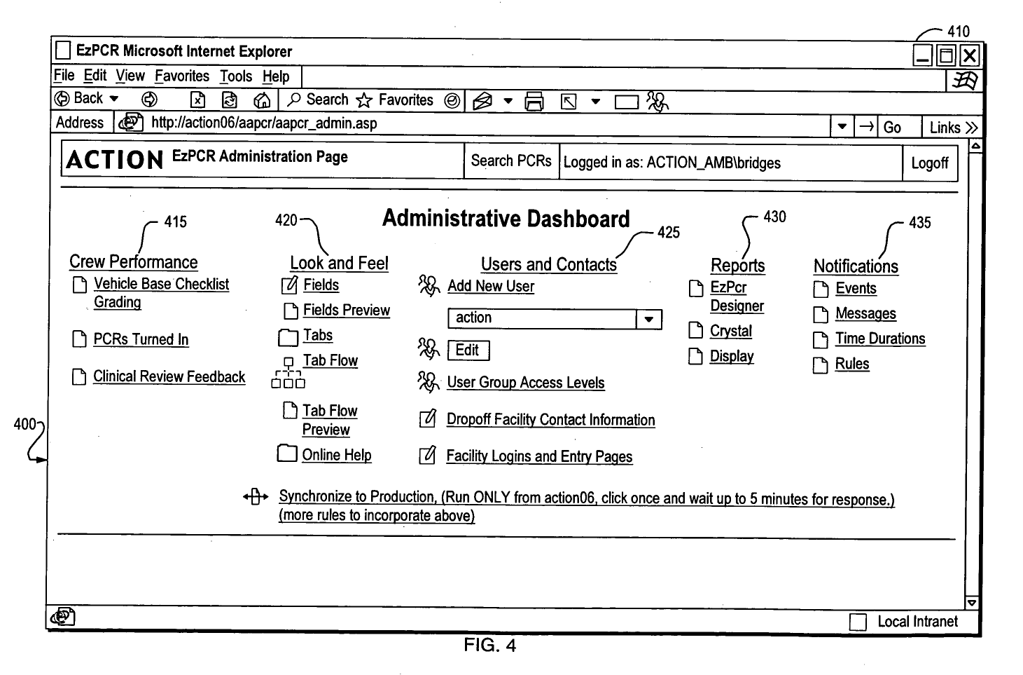

Main system. Administrative dashboard module. The administrative dashboard of the preferred embodiment provides a means for users to drive the way that the software works for them. Different functionality is available depending on which user is viewing the dashboard. Through the dashboard, an IT administrator can set up users and contacts, specifying who receives what type of event notification, and laying out/specifying fields for the PCR form and report. Supervisors can use the turned in checklist or compliance checklist. The administrator can also rate employee performance and enter feedback if the HR module is used. FIG. 4 is a screen shot of an embodiment of the administrative control page (dashboard), according to one aspect of an embodiment of the present invention. In FIG. 4, page 400 is presented as a web page in standard browser 410. Users may choose actions in five categories: crew performance 415, “look and feel” (field and tab administration) 420, users and contacts 425, report administration 430, and notifications 435.

In particular, administrators can use the dashboard to add, edit, and set defaults, set options, activate/deactivate, and move fields and tabs around on the PCR Run Form; see a list of all trips and mark which ones were turned in on paper, in order to ensure complete paperwork for all trips; design reports, either through the system Designer tool or a facility like Crystal Reports; pick any condition for any system field and set up a notification when the crew members sign off on their trip; specify conditions for notifications that monitor all of the databases and continuously check for red flags; and add and edit users, set up user permissions, and maintain contact information. Other optional features include provision of clinical feedback on each trip, and a personal assessment portal where each crew member can see their own statistics, including but not limited to, how many IV attempts were successful, how many calls of certain types they have done, and how many times they were late.

Users and Contacts. In a preferred embodiment, the system supports multiple levels of access for users, each with a specialized, configurable set of permissions within the system. Users can be placed into groups having different access privileges, with starting web pages to view, notifications, and reports being available. In a preferred embodiment, each user is associated through the system with the following types of information: Active Directory username (i.e. action_amb/jbridges), Access level (Administrator, Supervisor, Facility, General), CAD user (if interfacing with a CAD system), Email Address, Company, Logo, and Notify events. Each access level is associated with starting web page to view and levels of access to information.

Typically, system users are assigned to groups based on their responsibilities within the organization's operating structure. The system administrator user, for example, has the permissions to create, access, and modify all records throughout the system. The system administrator also has full access rights to add, delete, and edit user profiles throughout the system. The operator/crew member (General user) has the permissions to access and modify records assigned to them through the CAD system. The External Operator (facility) has the permissions to enter and modify records that are flagged as originating from that external operating unit, such as a fire department that logs patient care information with the emergency services provider. The system preferably permits multiple external operating companies to be defined, with associated users that will have access only to those records assigned to their own operating unit.

Coordination of user data is preferably performed by the administrator. This allows the system user database to be authenticated against a standard domain/active directory, but also to coordinate the specific users with unique user identifiers used in third-party call-tracking applications, such as RightCAD.

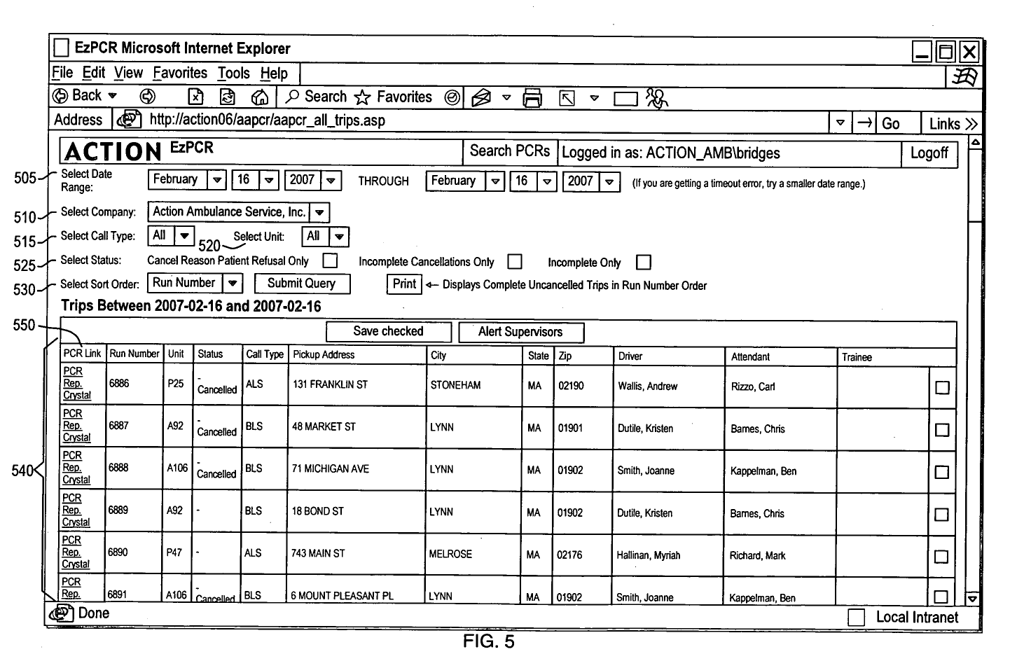

Search PCRs. In a preferred embodiment, the system allows users to search through appropriate PCRs and view needed information. Users with different access privileges are able to see different sets of PCRs. Preferably, each user can only see PCRs pertinent to them. For example, supervisors and administrators can see all trips. FIG. 5 is a screenshot of a screen providing a list of all trips, as would be seen by an administrator. In FIG. 5, the user can select the date range 505, company 510, call type 515, unit 520, and call status 525 as desired for review, and specify a sort order 530 if desired. The relevant trips, with pertinent details, are shown in list 540. PCR link 550 allows the user to click and view the full Patient Care Report.

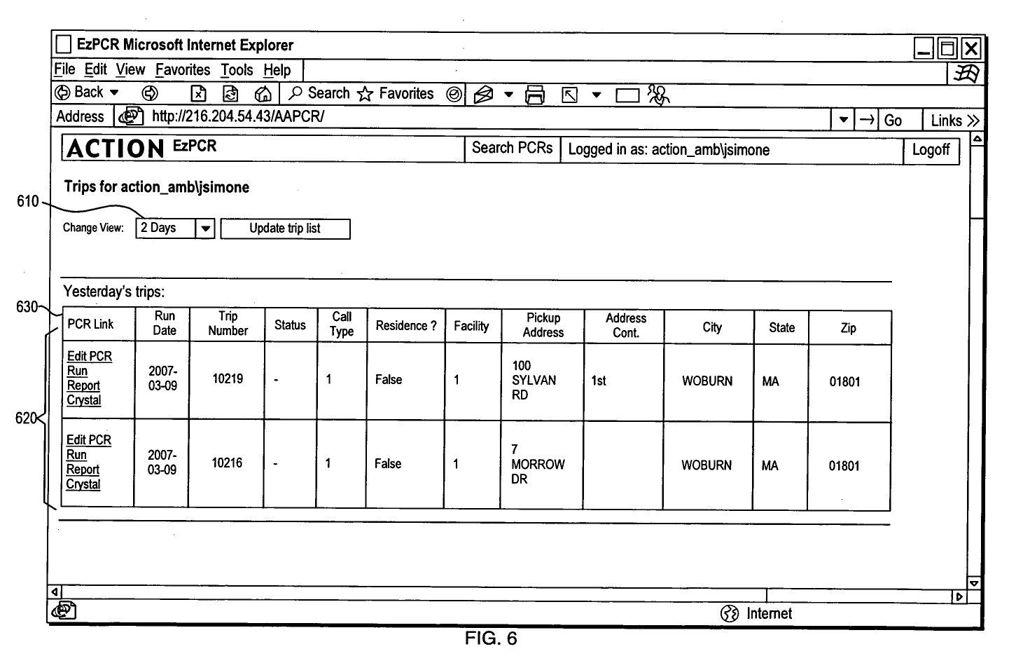

In a preferred embodiment, each general user (ambulance crew member) can only see PCRs for trips that they worked on, and each facility user can only see PCRs for trips that went to or from their facility. FIG. 6 is a screenshot of a list of trips taken by a general user, as would be seen by that user according to an aspect of the present invention. In the embodiment of FIG. 6, the user can select the period covered 610 in list 620. PCR link 630 allows the user to click, view, and, if desired, edit the full Patient Care Report.

Reports. In one aspect, the system permits flexible definition of report layouts by an administrator. This definition can be dynamically suited to most reporting requirements. The report designer tool gives users the ability to create their own versions of patient care reports, displaying any fields that they want to see wherever they want to see them. Typically, ambulance crews go through the online form on a web browser tab by tab, typing in information about their care of the patient. They can access this form through computers in their trucks, or at any base or Internet connection. The setup and appearance of this form can be changed at any time by an administrator, who can add fields, change fields, and turn them on or off. These changes will then be seen right away by EMTs in the field. Administrators can also specify which fields are required, and change this at any time. Administrators can specify which fields they want displayed in a report, and where they would like them placed. They can also, if they choose, design a report through for example, the Crystal Report Designer tool, and then use that report instead or in addition to reports generated by the system.

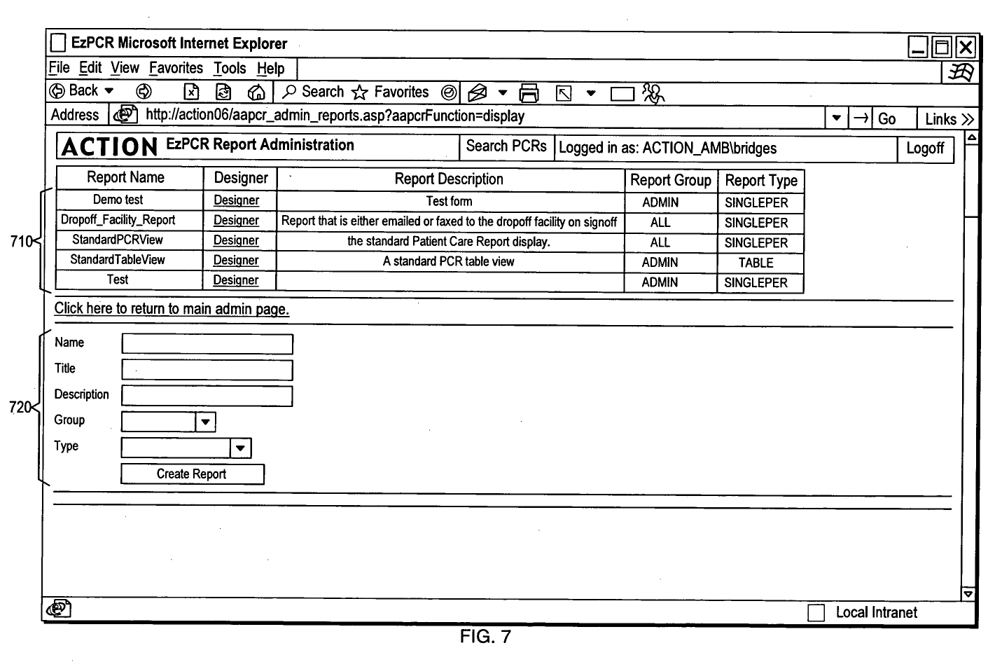

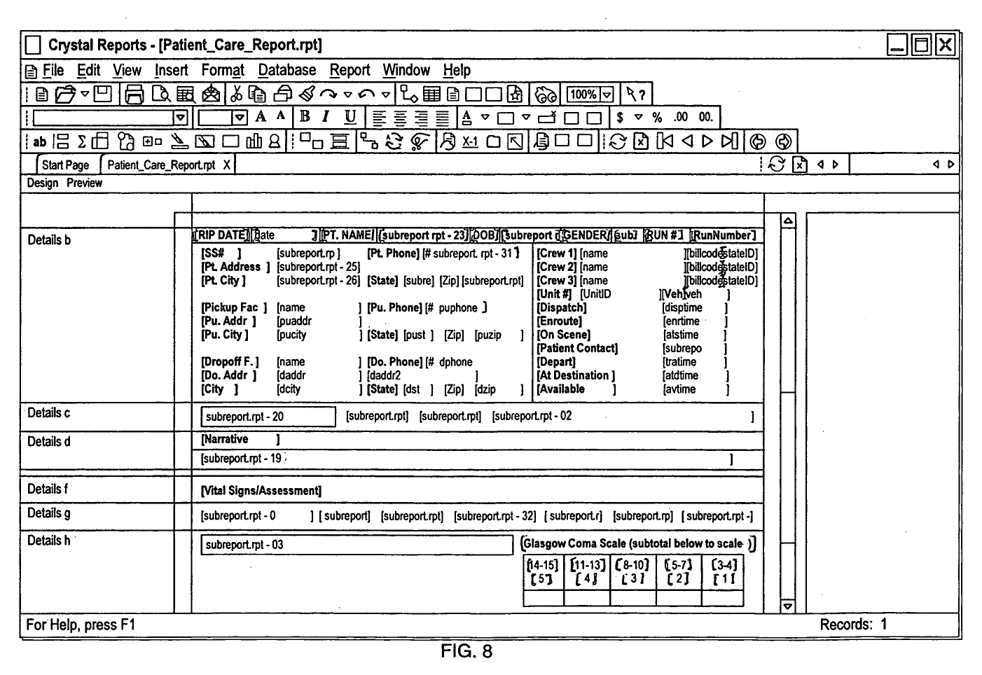

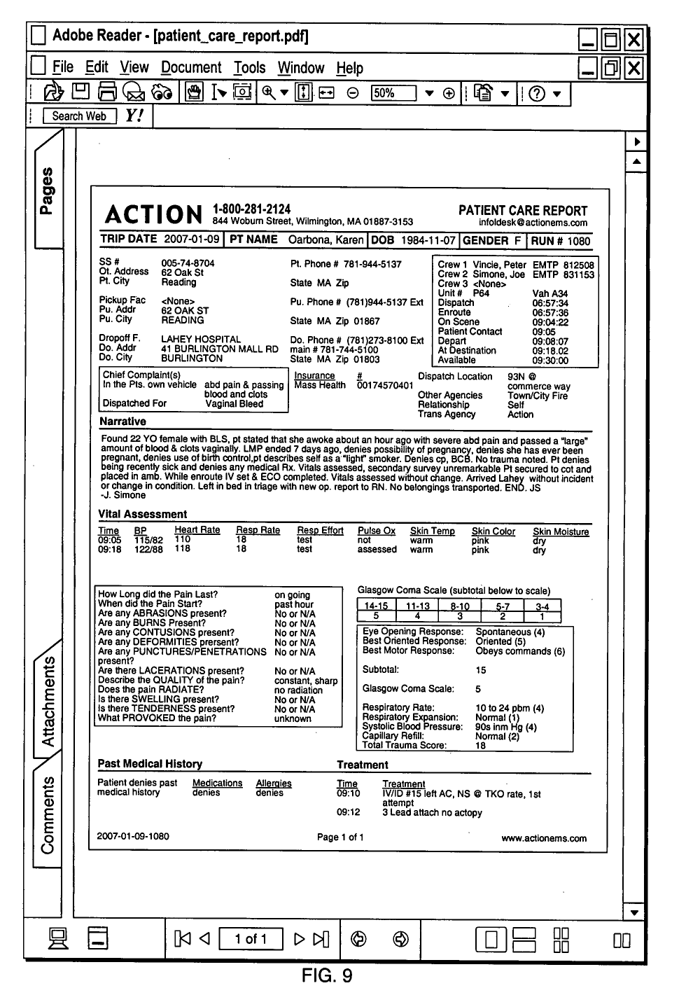

FIG. 7 is a screenshot of an embodiment of a screen from which report format editing may be initiated, according to one aspect of the invention. In the embodiment of FIG. 7, the user may select from a list 710 of existing reports to edit or may specify and create a new report 720. FIG. 8 is a screenshot of the native format of a report. FIG. 9 is a screenshot of a populated version of the edited report.

Data Collection System. The Data Collection System collects information for Patient Care Reports. The Data Collection System preferably includes at least the Electronic Run Form function, the Turned In Checklist function, and the Compliance Checklist function.

PCR Status Flow. The system is centered around the specific activities surrounding the processing of a PCR. In one implementation, the allowable status levels for a PCR in the system are:

NEW—A PCR that has been added to the system based on a new CAD entry.

INPROGRESS—A PCR that has been selected by an operator to begin entry.

COMPLETE—[CLOSED STATE] A PCR that has been verified by an operator. At this point the PCR is locked from content changes.

DELIVERED—[CLOSED STATE] A signed PCR that has been delivered via fax, email, or by review by the customer (such as on a terminal in a hospital by a hospital employee).

The status of a PCR also falls into one of two categories—OPEN or CLOSED, indicating whether the PCR is still active or can be archived.

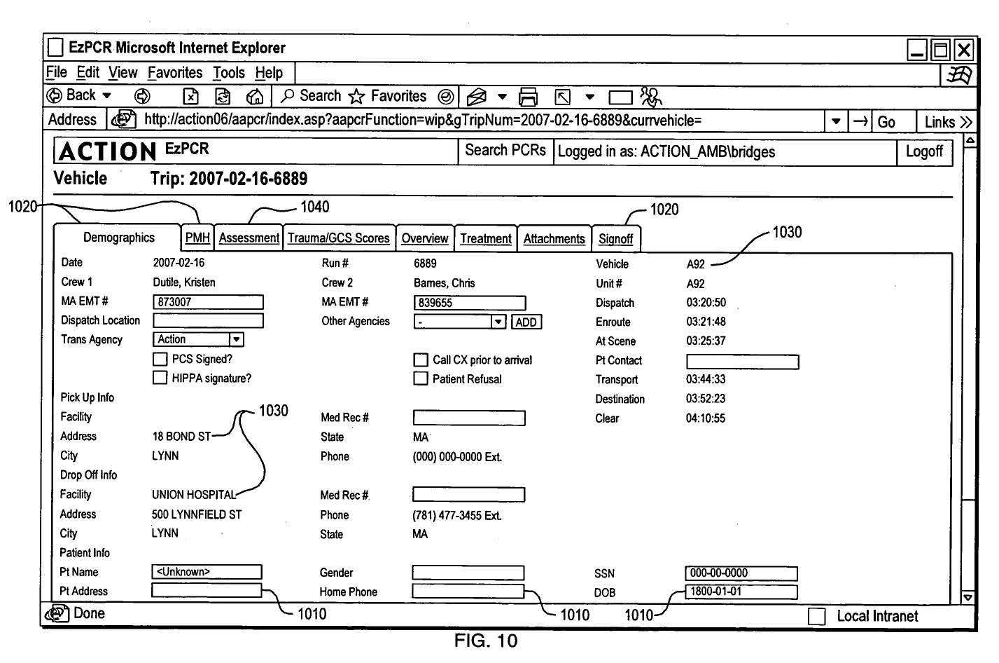

Electronic Run Form function. An example of a screen into which crews may enter data for a Patient Care Report according to one implementation of the invention is shown in FIG. 10. In FIG. 10, patient, trip, and treatment information are entered as appropriate into fields 1010. Multiple screens are provided, accessed by tabs 1020. In the embodiment of FIG. 10, certain fields 1030 have been pre-filled with data supplied by the CAD (computer-aided dispatch) system.

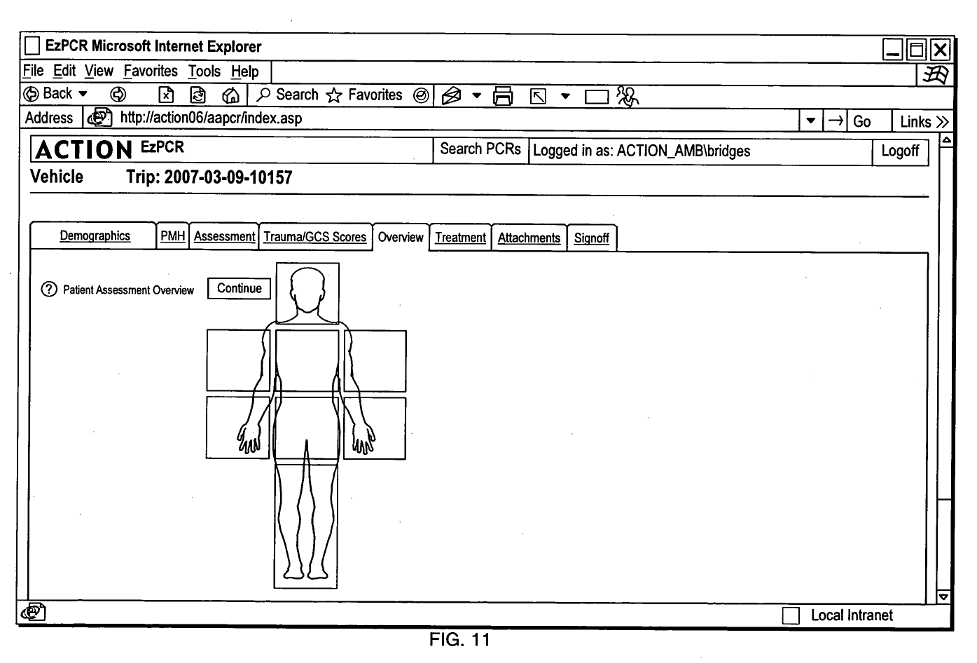

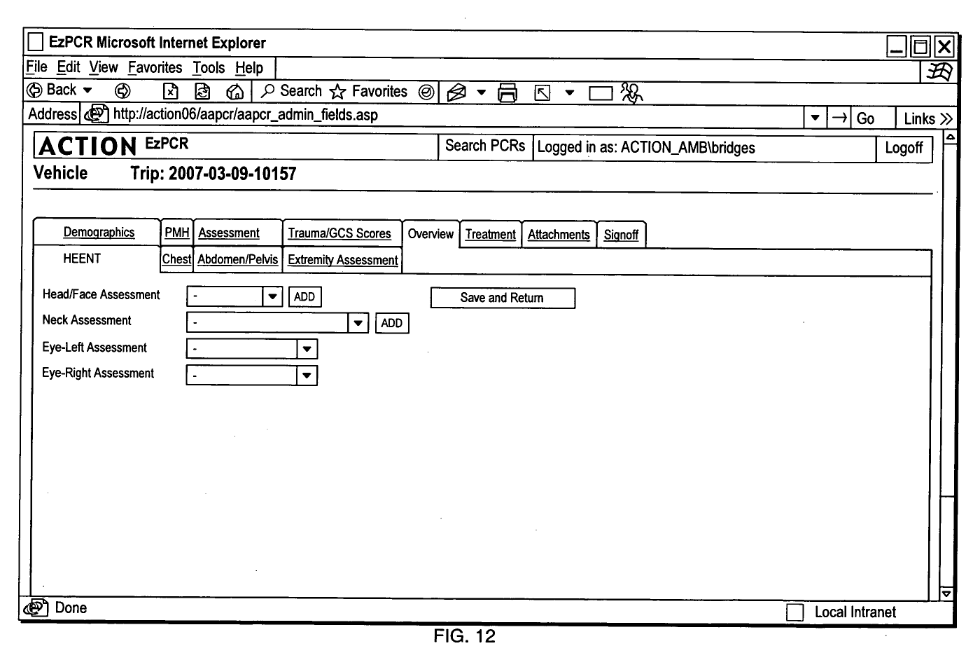

FIG. 11 is an example of a PCR patient assessment overview entry screen, which is accessed via tab 1040 shown in FIG. 10. In one embodiment, the assessment figure is the image of a person. When a specific part of the body is selected, the user is directed to that page with the appropriate system assessment. Once all questions related to that specific part of the body are answered, the image of that part of the body changes color to signify that this part of the assessment is complete. This is meant to prevent questions not being answered in the event that the EMTs are not able to complete the PCR in a single session. FIG. 12 is an example of a PCR patient head, eye, and neck assessment entry screen.

In a preferred embodiment, functionality and an interfaces are provided so that the PCR is prefilled with data from a computer-aided dispatch (CAD) system. In this embodiment, ambulance crews open up a web run form that is automatically pre-filled with data that is already in the CAD system, including information from the original call to the dispatch department.

In the preferred embodiment, as soon as the ambulance crews sign off on their trip, a run report is automatically faxed to the destination facility. It can optionally also, or alternatively, be emailed to the facility or viewed through a searchable web page. As soon as the signoff button is pressed, the clinical information on the PCR becomes locked and uneditable. If necessary, supervisory staff can unlock a trip. After changes are made, the PCR is then automatically refaxed to the destination facility. In addition, all versions of data entry are automatically timestamped, and marked with username of the person who made the change.

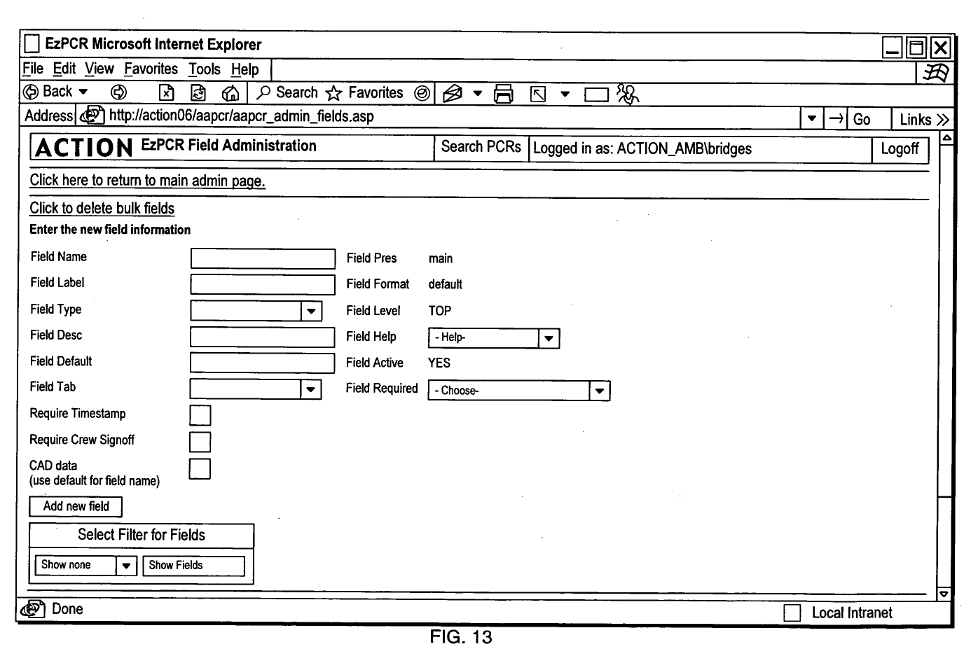

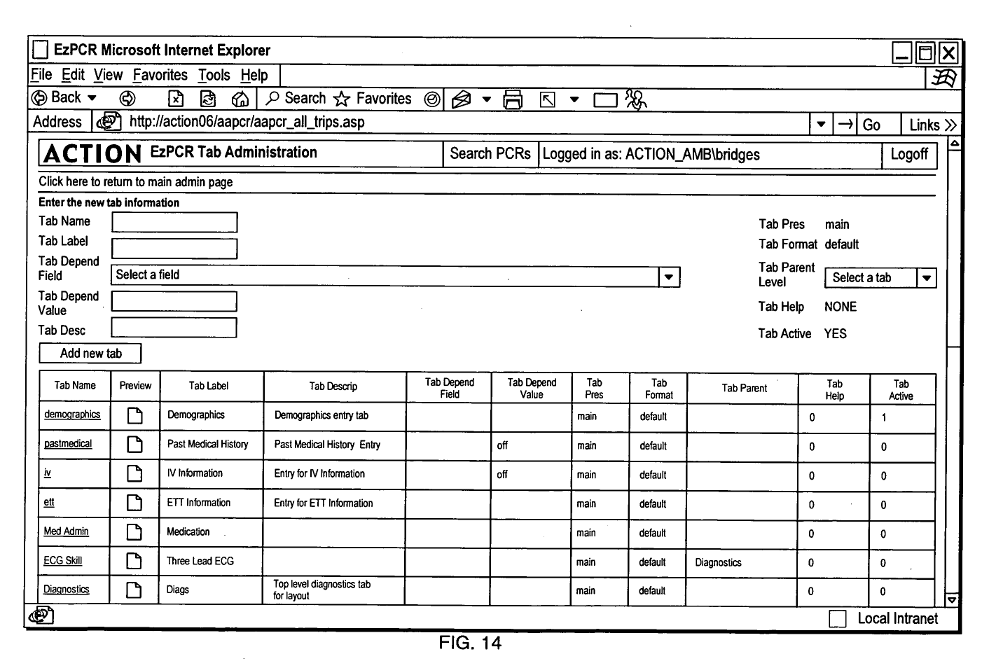

Field administration. In one particular aspect of a preferred embodiment of the present invention, the system permits user creation of report fields, allowing the user to customize the report to the user's particular needs. This capability makes the present invention robust and flexible, requiring little, if any, tech support to help the user administer the user's own system. It also provides the user with the flexibility to either collect extra data or to remove data sets for which there is no reason to collect data. In this way, the present invention is completely driven by the user. The database is also created in such a way that the user has control of the creation of fields, activating or deactivating data points. This ability is one of the unique aspects of the present invention. FIG. 13 is a screenshot of an embodiment of a screen from which field administration may be initiated, according to one aspect of the invention. FIG. 14 is a screenshot of an embodiment of a screen at which tab administration may be performed, according to another aspect of the invention.

In one aspect, the present invention permits flexible definition of the fields to be tracked by an administrator. Definition can be dynamically suited to most workflow processes. The flexible nature of the definition of the fields is accomplished through the use of the web-based client/server architecture, centralizing the storage of the field definition information as well as the data itself, and leveraging standard HTML elements to provide seamless cross-browser/client portability. Fields are not static elements in the table structure, but rather a relational connection to a separate field table with a standard data storage table. In this aspect of the invention, administrators can specify and change which fields are available for crews to enter information for their PCRs. Administrators are able to design the run form by specifying which fields, tabs, names, options, default values, whether they are required, and more. They can create new fields and tabs, move them around on the web page, turn fields and tabs on or off, specify which are required, change the tab flow order at any time, change the field layout on each tab, and have changes automatically display on the form the next time a crew member opens up the page. They can also configure notifications to be sent if pieces of the report are missing when crew members sign off.

The preferred field definition method is based on several deterministic characteristics, including the name of the field, the type of field, the default for the field, and the description for the field. The type of field is based on standard HTML form elements, or on composite system-specific field types. This provides a flexible definition method for creating enumerated lists for multiple choice form elements, such as radio buttons or drop down lists, The system seamlessly overrides default with selected database fields. The description for the field allows integral documentation for maintenance. Contextual help selection on a field basis may optionally be implemented by the user, in order to permit the system to automatically and simply add context-based help throughout the system.

Preferably, the field information is kept in separate administration tables for the system. This allows maintenance of the system at any time, and data is stored in the core database by reference to the unique identifier for any given field. This allows fields to be “turned on” or “turned off” (by removing the field from the active workflow), to track data as necessary by either government mandate, or by process choice. This information will be correlated automatically with older data if a field is then turned on again, because the unique identifier is retained.

The user of the system is shown a workflow that is based on a multi-level tabbed presentation of the data fields to be collected. This multi-level workflow is preferably completely configurable by the administrator. The tabs are typically defined with the following characteristics: the name of the tab, the label of the tab, the level of the tab, whether the tab is enabled/disabled, and the order of the tabs relative to each other. All fields that are to be collected can be added by the administrator to an appropriate “enabled” tab. The placement of fields on the tab uses standard HTML formatting table elements, but allows the user to manually move fields as desired. Formatting information is stored on a per-field basis. This information keeps the x and y coordinates for a given field. The placement routine collects the overall field placement structure based on x and y coordinates. The field information is stored in the database, retrieved at the ASP layer, formatted into rows and columns, and then rendered through standard HTML code to the browser.

The administration tool to adjust the layout leverages this system, but provides the user with adjustment icons to allow vertical and lateral movement, and width adjustment on a per-field basis. The administrator can move or adjust the width of fields one increment at a time. The report layout system leverages the existing field database, and the tab placement code, to provide report layout definitions in a similar fashion, allowing the user to discretely place fields by x and y coordinates, and the width of the field presentation. New fields do not conflict with existing layout criteria, because the system automatically puts new fields at the last row of the layout, and the routines do a per-field swap of available coordinate and width data to insure no field is removed or not displayed.

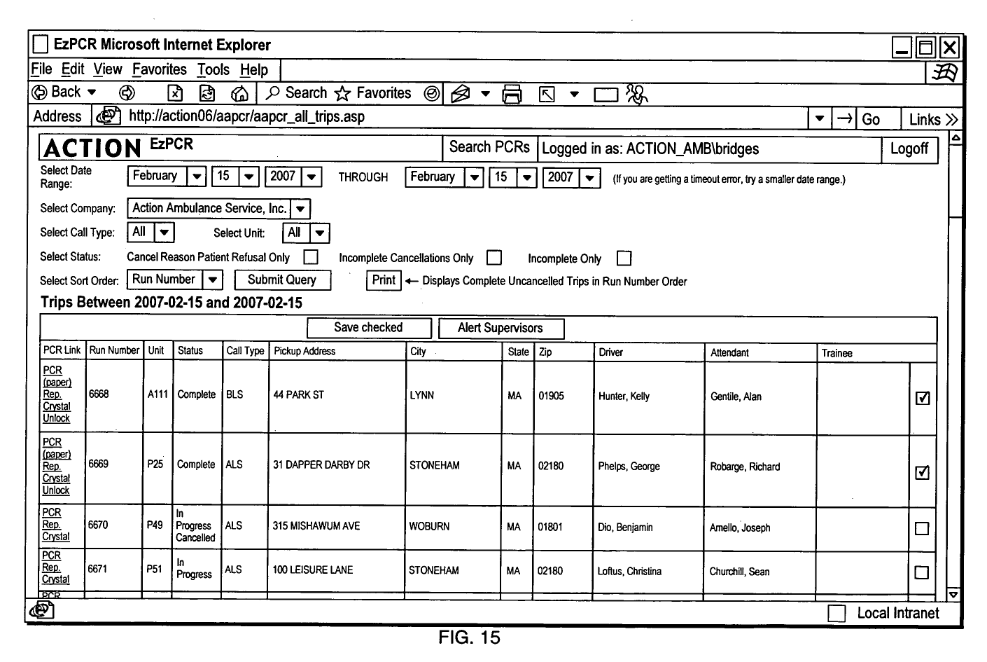

Turned In Checklist. The Turned In Checklist view shows a supervisor or administrator all trips. Using this facility, supervisors can view all ambulance trips on a specific day or date range, and find out the status of each PCR. This allows for the reconciliation of any trips that have been completed on paper. If a CAD interface is involved, it even shows trips that have been dispatched but not yet started to be filled out. Supervisors and administrators can check off if any of the trips have been turned in on paper, and make sure that there is complete documentation on all trips. FIG. 15 is a screenshot of an embodiment of a checklist screen according to one aspect of the invention. Whenever a trip has been completed, whether electronically or by paper, it becomes locked. Through the complete checklist, users with access can unlock trips and change their status back to IN PROGRESS.

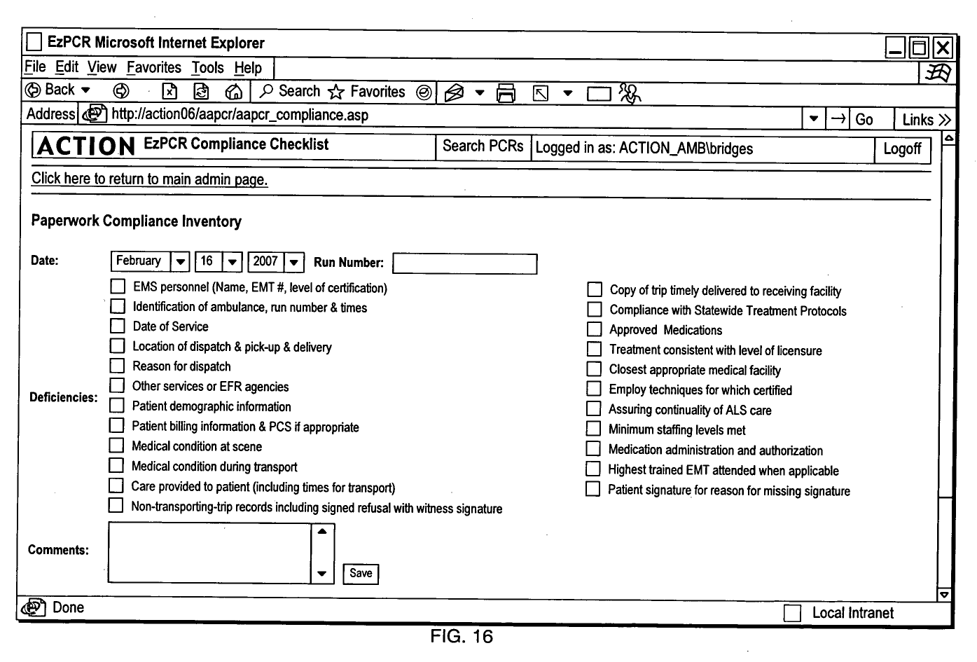

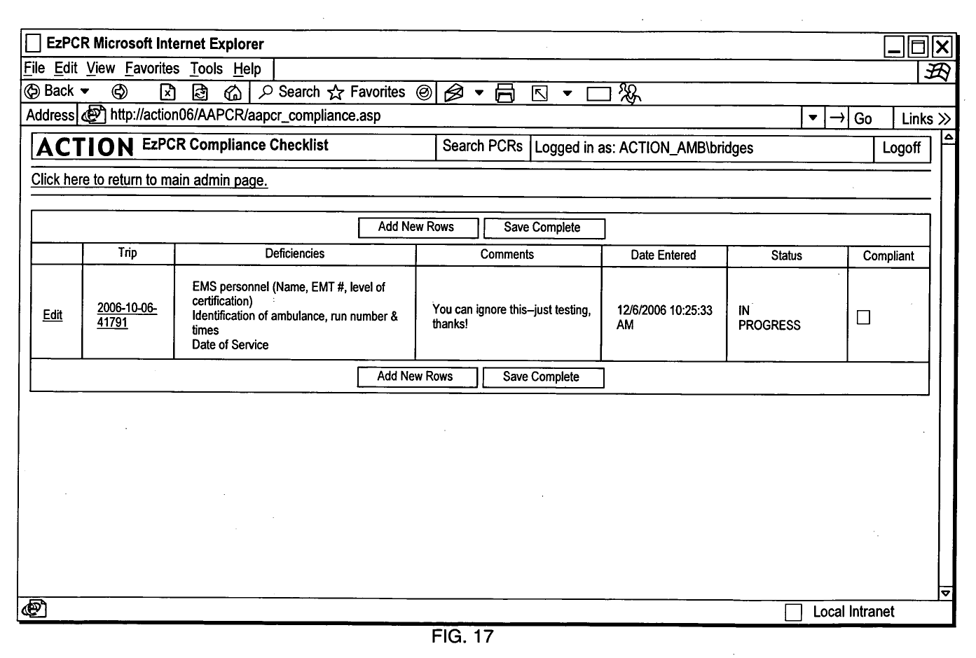

Compliance Checklist. Using the Compliance Checklist facility, an administrator may create a checklist of company or state policies to which each PCR must adhere. This checklist allows a user to mark whether there are any deficiencies in any of the PCRs, as shown in FIG. 16, and in addition, to notify people who can fix these deficiencies, as shown in FIG. 17. In this manner, administrators may create their own checklist of rules on what makes a PCR compliant with company or government policies. This checklist can be used to look at individual PCRs and automatically notify those who can help with adding or updating appropriate information to the PCR.

In addition, crews frequently like to be able to review run reports that they have submitted in the past. With the present invention, they can recall that information. In a preferred embodiment, crews with general access may only recall reports that they themselves were a party to, either as a driver, attendant, or an extra person on a particular call. Crews presently enter vast amounts of data points. These data points are query-able by the quality assurance department, so it is possible to save on Q/A assessment. It is important that the system be intuitive enough to be able to identify protocol violations and send notifications (via email or page to phone) to the appropriate responsible people to look at when paramedics are not treating patients based upon what the patients chief complaint is, and to have almost a computerized decision tree that allows going back to review these reports in essentially a real time basis instead of waiting days or weeks later. The present invention provides real-time information on the performance level of providers in the field and the opportunity to do pre-hospital studies by customizing data in fields that are important to the particular study.

Notification systems. There are several types of notifications in the preferred embodiment of the notification system: Email/Fax PCRs, Events, and Self Monitor and Notify.

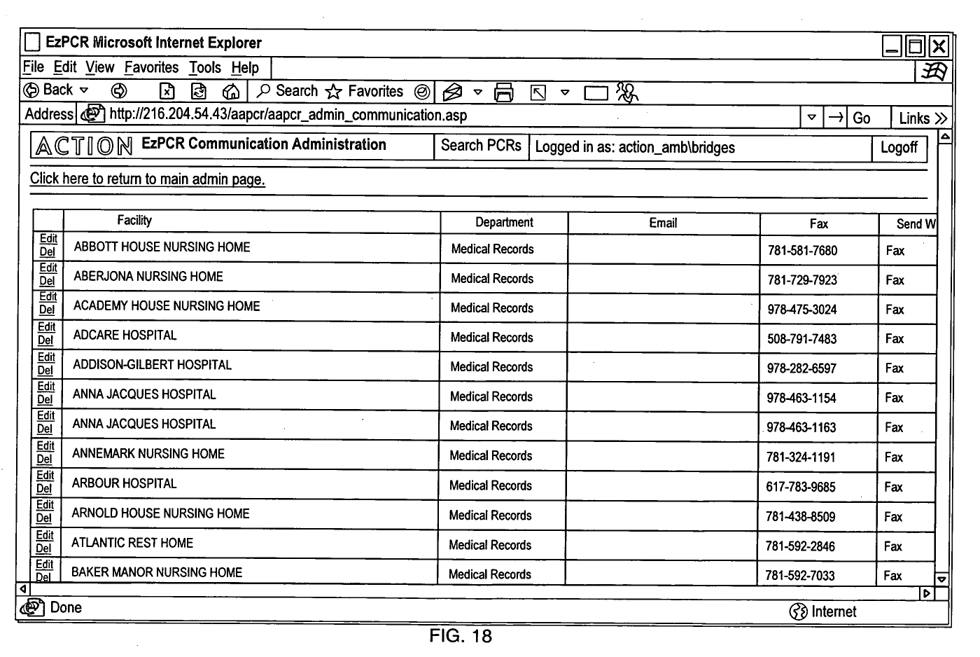

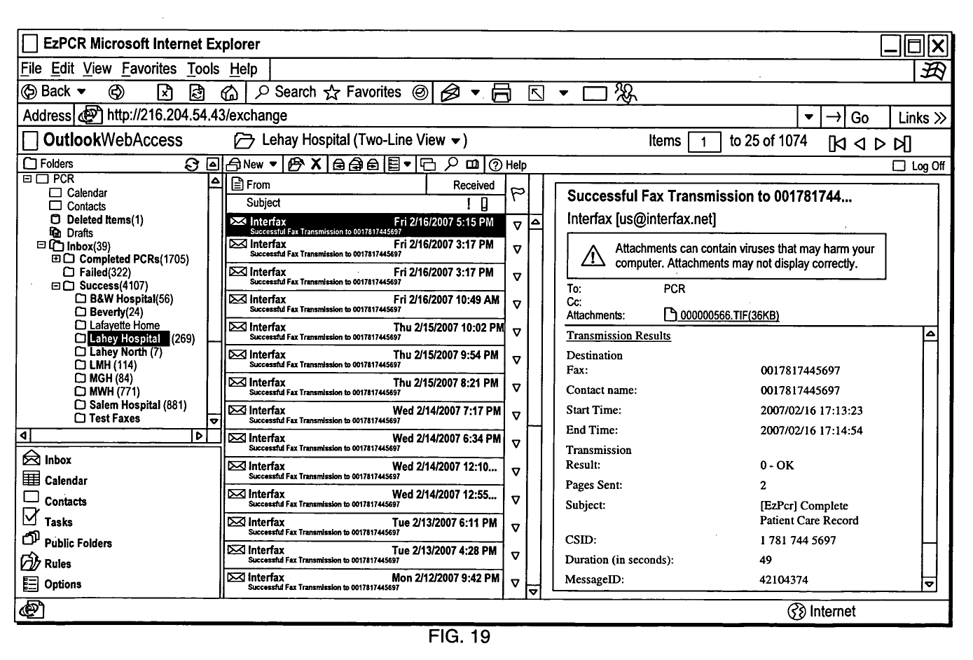

Email/Fax PCRs. In a preferred embodiment, when ambulance crews sign off on a patient care report, a report is automatically emailed and/or faxed to the destination facility. Redundancies are built in so that if there is any kind of technology failure, appropriate people are notified in order to ensure the report reaches the facility. When crews press the signoff button on their trip, a patient care report is automatically faxed to the fax number that has been entered for the destination facility. FIG. 18 is a screen shot of the screen into which facility fax numbers are entered. Confirmations that each PCR was sent are also viewable and searchable (as well as failures which need to be handled), as shown in the screen shot in FIG. 19. Failures are also forwarded to supervisors. In addition, there are redundancies built in. If email systems are down, a message is displayed on the screen for the crew member, asking them to print the report and hand-deliver it to the facility.

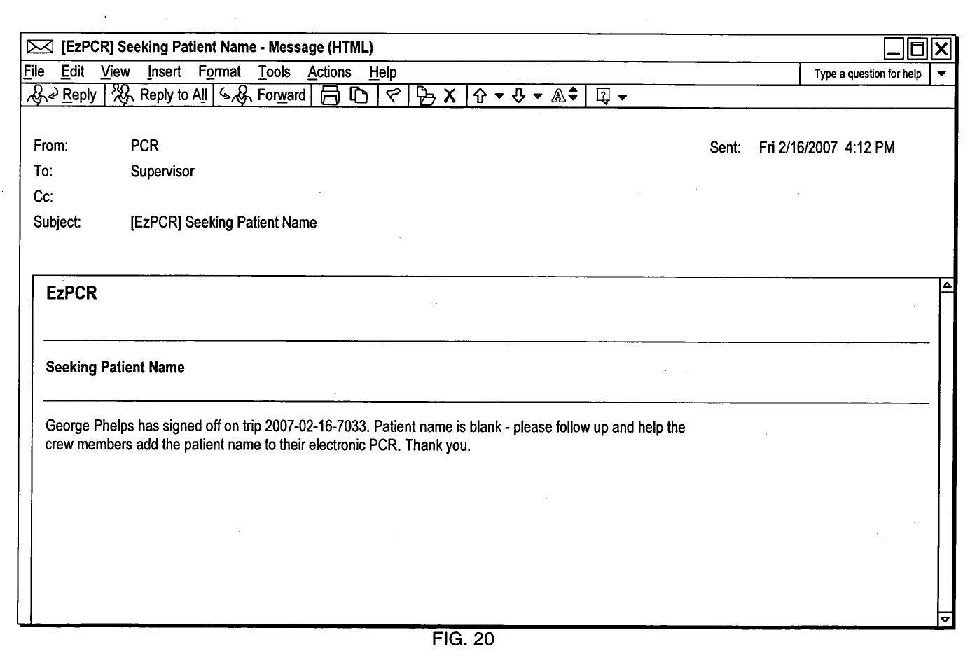

Events. Events are occurrences in the day-to-day use of the system, including signoff or compliance events. Event notifications are normally triggered by user interaction with the system (e.g. “button pushes”). These are preferably completely customizable by the user, in that the user can decide what events and parameters will trigger notifications. Users or user groups can be notified of specific events, as the company's operations need. This can be configured for any logic for any type of field in the PCR form that the company designs. An example of an email notification of the occurrence of an event is shown in the screenshot in FIG. 20. Users can create their own logic and send notifications to either user groups or specific users, based on information in any field in the Data Collection System. For quality assurance notifications, whenever there is a protocol violation or operational flag (i.e. a crew has been out of chute for too long), appropriate staff can be notified in order to handle the situation. The computer system automatically detects these issues and sends out emails and/or pages.

In a preferred embodiment, the Event Notification module notifies incident review staff of various actions taken by field providers while responding to a call. These notifications are sent in a real time mode, via email, pager, text message, instant message, telephone, facsimile, or any other suitable method known in the art, to alert the appropriate reviewer, affording the opportunity for a more reliable answer to any question, since the occurrence will still be fresh in the field provider's mind. The module has the ability to notify the safety officer when specific type of safety rules have been triggered thus allowing him/her the ability to inspect the digitally recorded patient care report to investigate the potential violation. This gives the safety officer a frame of reference for the situation before making a determination. This notification module can, for example, alert the narcotics review officer to ensure the proper pain management technique was used in various scenarios. The reviewer can investigate why the field provider initiated a specific pain management technique, in order to ensure that appropriate care was administered by the provider. A secondary benefit from a preferred embodiment of this module is the digitally recorded use of reviewed narcotics in order to track various trends in pain management techniques, which further provides the facility with a usage log for later interpretation by the appropriate parties, if necessary.

Self Monitor and Notify. In a preferred embodiment, the system automatically monitors its own databases periodically to catch any issues, and notifies appropriate people of specific situations. System Monitor and Notify. The system also has the optional ability to monitor the databases of third party tools and to send notifications of specific conditions and problems. Monitor notifications are triggered by specific conditions that occur within the system software and/or related software. In a preferred embodiment, the software is scanned automatically for the presence of triggering conditions. In one embodiment, the user may choose whether or not specific notifications will be made, but will not customize the triggering parameters, but it is within the scope of the present invention to also have the triggering parameters be settable by the user.

Human Resource Module. The optional Human Resource (HR) module allows for information about various employees to be recorded for performance feedback. The HR module enables companies to collect additional feedback about each employee and report on it in a systematic way for their performance review. In a preferred embodiment, there are several features included in this module including, but not limited to, Vehicle/Base/Checklist Grading, Clinical Review, Time and Attendance, and Crew member performance.

In one aspect, Vehicle/Base/Checklist grading provides supervisors with the ability to grade an assigned crew combination based on various criteria, such as how clean the vehicle is kept on the inside and outside, how clean and orderly the crew quarters are maintained, and how well stocked the vehicle is at the end of a shift, in addition to grading on completeness of all paperwork for incidents and/or occurrences during the designated shift time. This provides supervisors with an objective means with which to evaluate employee performance. The crew member is given a specific grade along with an explanation as to determination of the grade. This will trigger a notification to the graded crew along with the appropriate feedback.

In another aspect, the Clinical Review feature permits a Clinical Peer Review (CPR) Committee to review digitally recorded patient care reports. This optional feature may be configured to operate in a variety of methods. When a new person is hired, the system will designate that individual for Peer Review for a given period of time or until CPR personnel have determined that the provider has achieved a satisfactory level of care. Once this has been determined, the crew member can be clear of further peer review. In the same respect, a provider can be flagged for a peer review and notified of such action. This review procedure will continue until the CPR personnel are satisfied with the clinical procedures performed. Part of this review procedure can include the ability of the CPR personnel to select various digitally recorded patient care reports. Once each report has been reviewed, the CPR personnel can leave feedback or mark the report incomplete, as well as leave feedback forcing the field provider to complete the report before finishing their next shift. Each time an action is taken by CPR Personnel, the field provider is notified by e-mail immediately to take action. This back and forth review scenario is recorded and shown to the crew member on a performance review report, as well as on the CPR report each time a CPR investigator references the patient care report. This audit trail permits management follow up later, if necessary.

Time and Attendance performance notification is the ability to track a provider's attentiveness on duty when assigned to various shifts during the week. This is an automatic tracking process that is then available to the field providers in their individual performance feedback reports. The providers see their on-time percentage, as well as their number of work hours lost due to tardiness, sick time taken, and other various reasons for a crew member not to punch in on time.

The optional Crew Member performance function provides a Crew Feedback Report as a way for management to show a crew member, via a web-based report, the crew member's performance in an objective manner. The various notifications are displayed in the appropriate categories, such as Out of Chute Compliance, Turn around Time, Collection Ratio, Clinical Review Grading, Vehicle Grading, Base Grading, Checklist Grading, and Time and Attendance Compliance. This report is sent to the crews via e-mail each month, so that they can be aware of their performance. This report also provides a breakdown per month, as well as year to date performance for each category. If necessary, a crew member can drill down to each individual incident giving them instant information to review themselves. The performance report is positive since the annual review process can reference this report that then makes the process more objective as well as relative for various potential rewards to the individual provider. One of the many benefits from this system is the immediate feedback to the field providers as to their performance. If for some reason a call is recorded incorrectly, the crew can request an adjustment from the dispatch unit to correctly reflect the performance. If approved, changes can be made that will then be reflected by the Human Resource Module.

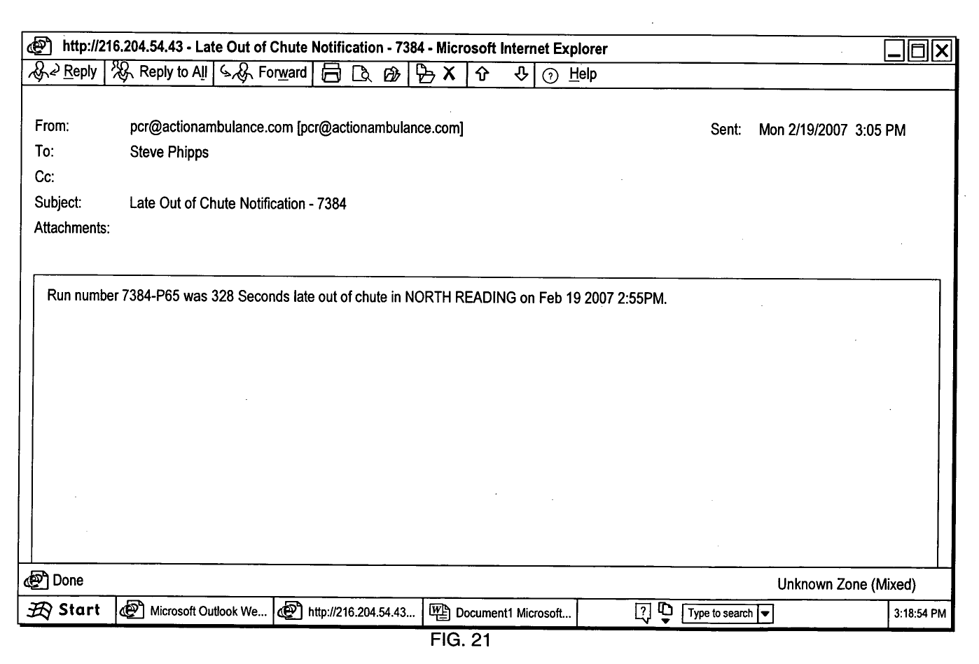

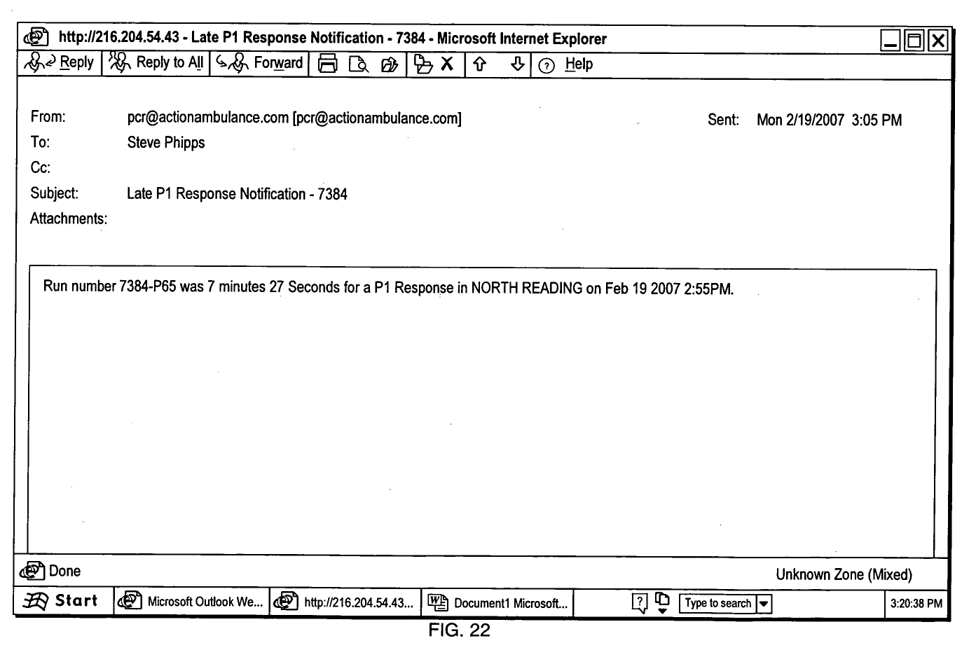

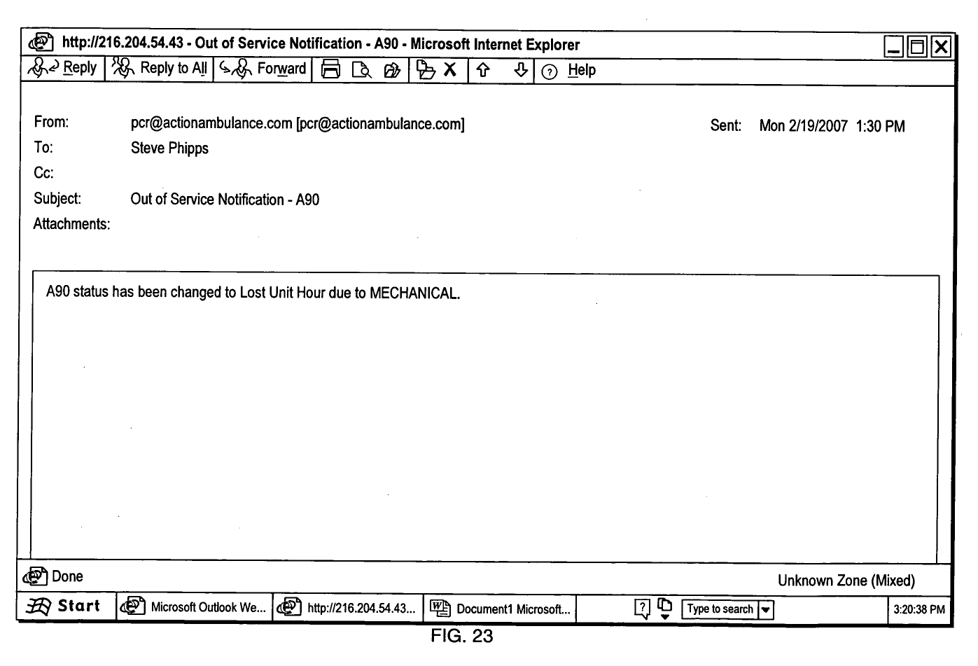

FIG. 21 is a screen shot of an example of an Out of Chute notification that a crew member and support staff would receive when the event occurs. FIG. 22 is a screen shot of an example of a Late Response notification email. Different notification priority levels are optionally possible. FIG. 23 is a screen shot of an example of an Out of Service notification that the support staff might receive.

Third Party Tool Interfaces. The system structure can easily be adapted to interface with other databases with third-party call tracking applications. In a preferred implementation, the system interfaces with the RightCAD application, using standard SQL Server databases. The system has the ability to interface with any or all of these types of third party software tools, such as computer-aided dispatch (CAD) systems, incident managers, fleet management tools, and time and attendance software. The system can, however, also serve as a stand-alone application. In particular, in a preferred embodiment, the system has the ability to automatically fill in fields by default in each PCR from a CAD system. Each user in the CAD system can be linked to a user in the system, and ambulance trips can be linked with each PCR. Integration with time and attendance software can also be beneficial—for example, it can be used to provide the ability of preventing an employee from punching out if the employees PCRs for the day are not yet complete.

In a preferred embodiment, there are also several maintenance screens. In one aspect, Field Supervisor Notification Administration gives the administration the ability to turn Field Supervisor Rules on or off, E-mail notifications on or off, and Human Resource Recording on or off. Field Supervisor Notification is particularly designed to notify the support staff and/or management of various negative scenarios that are occurring during an incident. Many times the supervisors will be notified of a problem only after the situation has occurred without having the opportunity to assist field providers. This missed opportunity diminishes the assurance of quality patient care. Although a single supervisor may or may not be able to assist in all occurrences where a notification is provided, timely notification affords a support team member the opportunity to act in a positive manner on behalf of the patient.

In another aspect, Field Supervisor Time Limit Configuration allows the user to set the various time limits for the predefined performance rules. PCR Notification Administration gives the administration the ability to turn PCR Notification Rules on or off, E-mail notifications on or off, and Human Resource Recording on or off. The PCR Notification System relies on the completed digitally recorded Patient Care Reports. Clinical Review Administration allows a user to select or deselect field providers for the clinical review process. Reporting Portal login maintenance allows users to setup login IDs and default web pages for various receiving facilities or communities. This enables the ability to remote review digitally recorded patient care reports for the appropriate authority as required by HIPAA.

In a preferred embodiment, the system provides automatic information sharing to internal departments. In this aspect, the billing department and supervisory staff open up another web page where they can check to make sure that all run forms of the day have been turned in, whether that be electronically or on paper. Each trip can be billed within 24 hours—an immense improvement from the paper run system. Vehicle maintenance staff can also be kept informed about parts needed and used. Crew members can have access to information in summary form about their trips, including what skills they have used, what types of calls they have done, or how many dollars have been collected on their trips. Summary data can be available to any type of audience, based on any type of query that may arise. For example, data such as what medications or other supplies are used on each trip may be utilized to inform how bases are stocked. The data collected in these databases can be synchronized on the fly, and also mined for evidence of patterns. These patterns can inform organizational practices, or permit the making of recommendations for the larger EMS field. New reports can always be generated based on new questions that arise, either through Crystal Reports or through a web interface. The flexibility of the system means that anyone can be notified of any data condition or pattern detected through any database system being used in the company.

User interface. In general, the system is designed to support three types of users: ambulance crews (general users), hospitals and other receiving facilities, and administrators, e.g. crew supervisors, billing staff, and IT staff. Each type of user has a different typical workflow, and will therefore see a different set and order of screens.

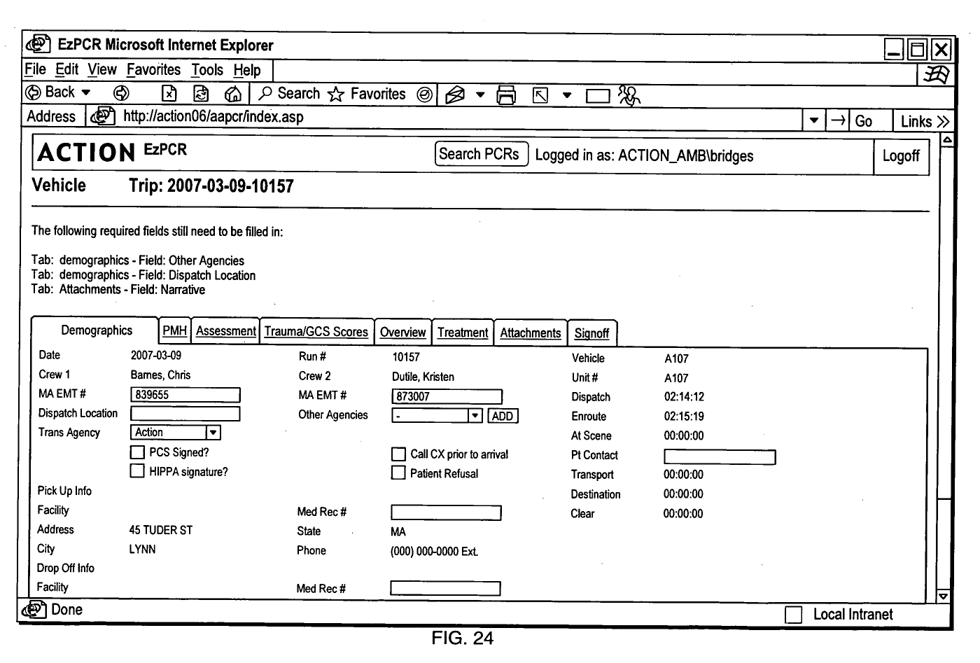

Ambulance Crew Workflow. In an example embodiment of an ambulance crew workflow: 1) The opening page shows a list of trips to which the crew member was dispatched (FIG. 6). 2) The user clicks “Edit PCR” to fill out the online run form (FIGS. 10-12). 3) On the last tab, the user signs off by pressing a button. If any required fields were not filled in, a message explaining what is wrong appears on the screen. A screenshot of an example signoff message is shown in FIG. 24. 4) After filling in the missing pieces, the user signs off again. A run report is automatically faxed, with a cover sheet, to the destination facility. If email systems are down when the crew member signs off, a message is displayed on the screen asking the crew member to either print the report and get it to the facility, or to ask a supervisor for help.

Hospital/facility workflow. In an example embodiment of a hospital/facility workflow: 1) The user opens a web page to search for a trip and retrieve information that was entered. The software only searches PCRs that went to that particular hospital or facility. 2) The user can then view the associated run report for the trip.

Administrator workflow. In an example embodiment of an administrator workflow, the opening page is the administrative dashboard. (FIG. 4). The administrator may: 1) Add or edit a user to give them access to the software; 2) Add a new field to a tab; 3) Check that PCRs have been turned in; and/or 4) Give feedback for a clinical HR review.

Online Help. The system optionally and preferably provides online help that gives additional information to the user regarding what is necessary to complete an online patient care report, as well as general usage guidelines. The help documentation is preferably maintainable through the administrative interfaces.

Implementations and configurations of the Software. The present invention is designed to be flexible in response to user needs and to work with any configuration of software already available to the service provider. It can stand alone or interface with databases in other tools, such as, but not limited to, Computer Aided Dispatch systems (such as RightCAD), Incident Reporting tools (such as QStatim), Fleet Maintenance tools (such as Fleet Maintenance Pro), and any other database tool that can provide useful information into a PCR form or data that can be analyzed in conjunction with PCR data.

The modules can be advantageously implemented on any of the large variety of platforms known in the art, using techniques that are well-known in the software arts. Table 2 presents some of the many suitable platform combinations, but any of the many other combinations known in the art may also be advantageously employed for implementing the present invention.

TABLE 2

| Current | | |
|---|---|---|
| Environment | Alternate Environment | Comments |
| Server: Windows | Windows 2003, Windows | Server based operating |
| 2003 | Longhorn | system supporting |
| | | Microsoft IIS |
| Database: SQL | SQL Server 7.0, SQL | Some installation |
| Server 2000 | Server 2005, Oracle, | adjustments may |
| | MySQL, Postgre SQL | apply. |
| Web Server: IIS 6.x | IIS 5.x, IIS 6.x | |
| E-mail Server: | Any Microsoft Exchange | SMTP is an alternative |
| Microsoft | Server 5.5 or above, SMTP | to proprietary e-mail |
| Exchange 2000 | (Simple Mail Translation | services. |
| | Protocol) Server | |
| Client Browser: | Internet 5.x, 6.x, 7.x, | |
| Internet Explorer 6 | Netscape 4.7 or above. | |

The core components of a preferred embodiment are built on the Microsoft IIS Web Server or a similar system, and uses the Microsoft Active Server Page (ASP) scripting language for server-side scripts. The data is stored in a Microsoft SQL Server database, accessed through the ASP ODBC methods. The additional external data required for the preferred embodiment is provided by the Computer-Aided Dispatch system, which also uses the Microsoft SQL Server, and is accessed through the appropriate ASP ODBC methods as well. The modules that leverage Microsoft SQL Server run all code from stored procedures that are embedded within the appropriate database, and the interface screens are created with ASP. These are portable, scalable, and flexible aspects of the invention, providing one of the many benefits of the invention.

In a preferred embodiment, the present invention has been implemented and utilized as the EzPcr system, by Action Ambulance Service, INC., Wilmington, Mass., using Microsoft Windows Server 2003 with IIS version 6, Crystal Reports Designer XI installed on the web server, Microsoft Exchange 2003 Email Server, MS SQL Server Version 8, RightCAD 3.9, EzPcr source code files and directories, including .asp and Crystal Report .rpt, and SQL Server Databases with ODBC connections accessible through ASP pages and Crystal Reports, as well as through direct database-to-database connectivity.

The source code of the Action Ambulance Services EzPcr implementation resides in .asp files, the layout of several native EzPcr databases, and in Microsoft configuration and networking. Microsoft Windows Server with IIS is used to serve up ASP pages to the Internet. Data is stored in a number of relational databases. EzPcr includes several databases that were home grown. Crystal Reports Developer tools include a Crystal Reports Server that works with IIS and the ASP code. This server is installed in the ASP file directories on the web server. Functions have been created within the EzPcr ASP code that will open up Crystal Report .rpt files to serve up professional-looking reports to web browsers. The ASP code is also able to export a report to the web server file system (for example in PDF format), which it can then send anywhere else. ASP pages, including a set of modular functions, interact with the databases to serve up HTML code and JavaScript to the web browsers. VB-Script and ADO are used. SQL is used to gather data from the data layer to the middle tier. CSS styling is also used. It is also possible to script out XML to transmit data to other types of software in the future. PL-SQL code is used at the database level. Email is sent through the SMTP protocol. It will be clear to one of skill in the art, that any of the many other languages, scripts, etc. known to those of skill in the art including, but not limited to, C or Perl, may be advantageously employed in the implementation of the present invention.

EzPcr also optionally interfaces with the databases of third party software tools. In particular, EzPcr can interface with any of the following four types of software. All four of these interfaces are optional, and can be chosen in any combination: (1) Computer-Aided Dispatch (CAD) System. Many CAD systems use a database to store information about emergency trips, patients, insurance, facilities, address, times, and more. This information can be automatically pre-filled into PCR forms through an ASP interface that reads from the CAD database through an ODBC connection. In addition, EzPcr is able to monitor a CAD database in an effort to look for operational issues. This type of interface is done through a database-to-database connection. Any popular Computer-Aided Dispatch (CAD) System that employs the described databases would qualify. The CAD System would be required to record the appropriate trip Information. (2) Time and Attendance System. Net Scheduler is one example of a Time and Attendance system with which EzPcr can interface. Functionally, for example, EzPcr can prevent ambulance crews from punching out until their PCR reports are complete. (3) Fleet Maintenance software. (4) Incident reporting software. While these four types of software are useful, it will be clear to one of skill in the art that EzPcr may also interface with other types of software tools or other parts of third party hardware or software system architectures, such as, for example, import or export scripts, UNIX boxes, Oracle databases, or APIs.

In a preferred implementation, EzPcr utilizes information from the CAD system to pre-fill information on the PCR forms. Ambulance crews are able to view what the software automatically fills in, read it, and change it if necessary. These changes may optionally be stored only in EzPcr or may write back to the CAD software. EzPcr also uses CAD information in the administrative interfaces. If a user needed to use EzPcr without a CAD system, however, it can be accomplished by entering all necessary information in through the EzPcr screens.

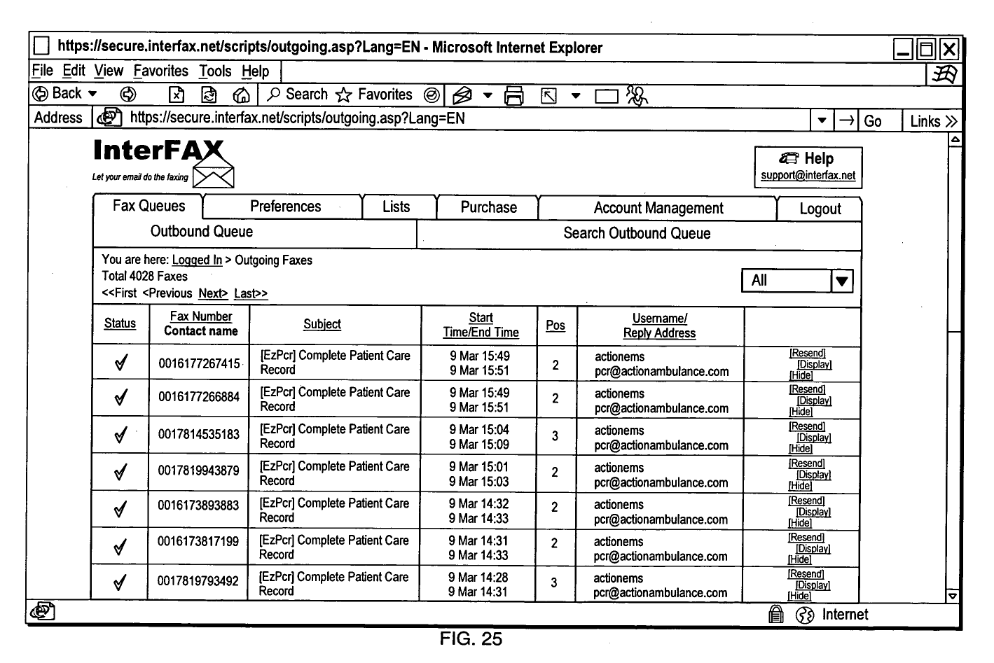

In the EzPcr implementation, PCRs are faxed to dropoff facilities through use of a third party service called Interfax, which is a faxing service over the Internet which charges per page. Faxes are sent to destination facilities by initiating an email to an Interfax email address that includes the fax number. Confirmation is received from Interfax as to whether the fax went through and at what time. A screen shot of the outbound fax queue through Interfax is shown in FIG. 25. As will be clear to one of skill in the art, any of the many alternative faxing technologies known in the art may alternatively be used, including, but not limited to, an in-house fax server, such as ProtoFax.

In the EzPcr implementation, Microsoft Exchange Email Server is used to manage email, but any of the many other email management systems known in the art may be advantageously used to perform this function. A PCR email account has been created from which faxes are sent. Fax confirmations and failure notifications are also sent to this account for easy searching, sorting, and forwarding through Microsoft Outlook. Email is sent from the application both from the ASP code and from the EzPcr databases, with the SMTP protocol. Notifications are currently sent as text messages to cell phones through SMTP email. The EzPcr users authenticate through Microsoft Active Directory in addition to security that is built into the ASP code and database. Each EzPcr user is mapped to an Active Directory user through tables in the EzPcr databases.

The present invention therefore provides a flexible, extensible, reliable tracking system for Patient Care Reports generated by emergency personnel. The operations drive the software, rather than the software driving the operations. The present invention is easy to use, the training curve is short, and users can easily navigate the web-based PCRs. The present invention solves the problems of illegible handwriting for medical records, inconsistencies in reporting practices, issues arising from data storage, volume, and retention, lack of accessibility of patient care reports, lack of real-time synchronization of databases, and the high cost of equipment and/or data entry activities. It provides an improvement over the manual method of completing Patient Care Reports by emergency personnel by providing accurate communication between the emergency personnel and recipients of the reports, eliminating human interpretation of handwritten forms, enabling more consistent reporting by providing standard responses to common form entries, providing for improved data retention by eliminating need for large paper copy storage, providing the ability to quickly and easily duplicate report information for backup storage, and providing improved accessibility to patient care reports through web-based online access.

The present invention also enhances process improvement efforts through statistical analysis of patient care history, enhances reporting and management options through web-based reporting interface, provides live synchronization and access to data between the ambulance crews and other people who need the data, provides the flexibility to change run form structure based on changing public policy environment or internal information needs, provides organizational learning for operational improvements, provides an ability to develop research questions based on clinical data in an effort to help the field, and employs flexible technology with the ability to adapt to future computer systems. In a preferred embodiment, the present invention also enables and integrates other functionalities, such as tracking performance levels of EMS staff, trend analysis, inventory tracking for resupply of EMS units with medications and miscellaneous medical supplies, tracking medical protocol adherence, data sharing with physicians and hospitals, and measurement of crew performance standards.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A computer system for managing patient care reports, comprising:
a processing system, comprising:
at least one patient care report format editing and definition facility;
a data collection system, the data collection system comprising at least a patient care report entry facility, for receiving data entered into a web-based patient care report;
a notification system for making notifications in response to predefined conditions identified in or by the processing system; and
at least one system database for storing information received from the patient care report entry facility; and
at least one client providing a real-time web-based user interface to the processing system.

2. The system of claim 1, further comprising a wireless communications device associated with at least one client, the wireless communications device providing a communications channel between the client and the processing system.

3. The system of claim 2, wherein the client and wireless communications device are accessible within a vehicle.

4. The system of claim 1, further comprising an interface to a computer-aided dispatch system having at least one computer-aided dispatch system database.

5. The system of claim 4, wherein data from the computer-aided system dispatch database is used by the processing system to at least partially prefill a patient care report for use by the patient care report entry facility.

6. The system of claim 1, further comprising at least one interface to at least one of: a human resources facility, an incident management system, a fleet management system, a time and attendance system, and report design software.

7. The system of claim 1, further comprising an administrative dashboard facility for coordinating access to the elements of the processing system.

8. The system of claim 1, wherein the notifications are made by at least one of: email, pager, text message, instant message, telephone, and facsimile.

9. The system of claim 1, the patient care report format editing and definition facility further comprising:
a report design facility; and
a report field and tab administration facility.

10. The system of claim 1, further comprising a patient care report search facility.

11. The system of claim 1, the data collection facility further comprising at least one checklist facility for confirming that the content and handling of an individual patient care report is in compliance with predefined procedures and policies.

12. A method for managing patient care reports, comprising:
providing a client having a real-time web-based user interface to a patient care report processing system;
providing a patient care report format editing and definition facility;
providing a patient care report entry facility, for receiving data entered into a web-based patient care report;
providing a notification system for making notifications in response to predefined conditions identified in or by the processing system; and
providing at least one system database for storing information received from the patient care report entry facility.

13. The method of claim 12, further comprising the step of providing a wireless communications device associated with the client, the wireless communications device providing a communications channel between the client and the processing system.

14. The method of claim 12, further comprising the step of providing an interface to a computer-aided dispatch system having at least one computer-aided dispatch system database.

15. The method of claim 14, further comprising the step of at least partially prefilling a patient care report for use by the patient care report entry facility with data from the computer-aided system dispatch database.

16. The method of claim 12, further comprising the step of providing at least one interface to at least one of: a human resources facility, an incident management system, a fleet management system, a time and attendance system, and report design software.

17. The method of claim 12, further comprising the step of providing an administrative dashboard facility for coordinating access to the elements of the processing system.

18. The method of claim 12, further comprising the step of providing a patient care report search facility.

19. The method of claim 12, wherein the patient care report format editing and definition facility comprises a report field and tab administration facility.

20. The method of claim 12, further comprising the step of providing at least one checklist facility for confirming that the content and handling of an individual patient care report is in compliance with predefined procedures and policies.
